(19) United States
(12) Patent Application Publication
(10) Pub. No.: US 2023/0354816 A1
(43) Pub. Date: Nov. 9, 2023

(54) PESTICIDAL COMPOSITION COMPRISING ELEMENTAL SULPHUR AND CHOLINE SALT OF PELARGONIC ACID

(71) Applicant: Hiteshkumar Anilkant DOSHI, Thane (IN)

(72) Inventor: Hiteshkumar Anilkant DOSHI, Thane (IN)

(21) Appl. No.: 18/022,068

(22) PCT Filed: Aug. 16, 2021
(86) PCT No.: PCT/IB2021/057526

§ 371 Date: Feb. 17, 2023

(30) Foreign Application Priority Data
Aug. 17, 2020 (IN) IN202021035357

(51) Int. Cl. A01N 59/02; A01N 37/02; A01N 25/14; A01P 3/00; A01N 25/04

(52) U.S. Cl. CPC A01N 59/02; A01N 37/02; A01N 25/14; A01P 3/00; A01N 25/04

(57) ABSTRACT

The present invention relate to a pesticidal composition comprising elemental sulphur, choline salt of pelargonic acid, and at least one agrochemically acceptable excipient. The invention particularly relate to a pesticidal composition comprising elemental sulphur in the range of 1% w/w to 95% w/w of the total composition; choline salt of pelargonic acid present in the range of 0.01% to 50% w/w of the total composition; and at least one agrochemically acceptable excipient. The pesticidal composition comprises particles in the size range of 0.1 micron to 50 microns. The present invention also relates to process of preparation of the pesticidal composition. The invention relates to a method of treating a plant, crop, plant propagation material, locus or parts thereof, a seed, seedling or surrounding soil with a pesticidal composition.

### 1. FIELD OF THE INVENTION

The present invention relates to a pesticidal composition comprising elemental sulphur; choline salt of pelargonic acid; and at least one agrochemically acceptable excipient. The invention more particularly relates to a pesticidal composition comprising elemental sulphur in the range of 1% w/w to 95% w/w of the total composition; choline salt of pelargonic acid present in the range of 0.01% w/w to 50% w/w of the total composition; and at least one agrochemically acceptable excipient. The pesticidal composition is in the form of wettable powder, water dispersible granules, broadcast granules or water disintegrable granules or spheronised granules, liquid suspension or suspension concentrate, oil dispersion, suspoemulsion, flowable concentrate, combination of capsulated suspension and suspension concentrate (ZC). Further, the pesticidal composition comprises particles in the size range of from 0.1 micron to 50 microns.

The invention further relates to a process of preparing the pesticidal composition comprising elemental sulphur in the range of 1% w/w to 95% w/w of the total composition; choline salt of pelargonic acid present in the range of 0.01% w/w to 50% w/w of the total composition; and at least one agrochemically acceptable excipient.

The invention furthermore also relates to a method of treating a plant, crop, plant propagation material, locus or parts thereof, a seed, seedling or surrounding soil with the pesticidal composition.

### 2. BACKGROUND OF THE INVENTION

In describing the embodiment of the invention, specific terminology is chosen for the sake of clarity. However, it is not intended that the invention be limited to the specific terms so selected and it is to be understood that each specific term include all technical equivalents that operate in a similar manner to accomplish a similar purpose.

The use of synthetic pesticides is on the surge over past few decades to meet the growing crop production demands, reduce pest population, protect stored grains etc. The continuous use of synthetic pesticides has resulted in negative effects such as pest resistance, pest resurgence, residual effect, toxic effect to non-target organism, pollution, health hazards and loss of biodiversity. Moreover, the indiscriminate and repeated use of synthetic pesticides also causes accumulation of pesticides in the soil which affect the soil properties and soil microflora thus altering its microbial diversity, biochemical reactions and enzymatic activity. The consumers today also are concerned about the amount of residual chemicals that might be found in food, ground water, and the environment.

Thus, there is a need for optimizing farming practices and providing alternative solution which would be non-toxic, safe to the humans and environment and does not impact the natural flora and fauna of the ecosystem.

Fatty acids are a class of natural compounds which occur abundantly in nature and have interesting and valuable biological activities such as antimicrobial, antifungal, antibacterial and herbicidal. Some fatty acids, such as caprylic acid, pelargonic acid and capric acid have herbicidal properties. In particular, pelargonic acid is a naturally occurring saturated nine carbon atomic fatty acid and has low toxicity to mammals and birds. Pelargonic acid is used to control weeds and as a blossom thinner. The choline salts of fatty acids such as capric acid, cacrylic acid, pelargonic acid have anti-fungal activity despite of the fact that the fatty acids are reported to have herbicidal effects.

However, the natural compounds may have shorter persistence in the environment and are vulnerable to unfavorable environmental conditions such as susceptibility to oxidation, temperature etc hampering their efficacy. Thus, there is a need for effective bio-solution or organic solution which will provide benefits equivalent to the chemical pesticides and yet be sustainable, non-toxic, biodegradable, have minimal impact on non-target organisms, resistance management, no residual effect, and also control pest thereby enhancing crop quality and yield and safety.

The role of sulphur as an essential and a growing nutrient and fertilizer has been long known. Sulphur is considered as organic in nature and is mostly available in its elemental form. Additionally, elemental sulphur is known for organic farming as a fertilizer and also for plant disease control as fungicide, insecticides including acaricides and miticides. The benefits of use of sulphur encompasses not only reduced dependency on use of chemicals as an effective mode of pest control but being organic in nature it is also environment friendly, increases crop yield, improves food safety, human, animal or plant health and quality of life.

Pesticidal composition comprising fatty acids are known in the art but there is no disclosure of a specific combination comprising choline salt of pelargonic acid and elemental sulphur.

WO2020104645A1 relates to a method for controlling or preventing a fungal infection on a plant or plant part by applying a composition comprising a choline salt of a C8-C10 fatty acid to the plant, plant part, or locus of growth of the plant and also relates to the use of composition as a fungicide. The application is completely silent on disclosure of sulphur in the composition.

WO96/28022 describes method for the control of established fungal or bacterial plant disease with the application of a fungicidal or bactericidal amount of a fatty acid, its salt or derivative, or mixture thereof, to the situs of said plant disease. The application aims to use fatty acid as the active ingredient in a composition to eradicate existing phyto-pathogens such as fungal infections or bacterial colonization and to improve or compliment the activity of other fungicidal and bactericidal chemicals when applied in a mixture. The patent application nowhere discloses application of choline salt of pelargonic acid in combination with sulphur or any other pesticidal actives. The application is also silent on application of the combination in specific formulation type with improved physical characteristics of the composition.

WO2018/164999A1 relates to an aqueous herbicide composition comprising at least one nutrient compound with an organic acid or mineral acid and an adjuvant which has a pH of about 4 to about 7. The aqueous composition aims to overcome the limitations associated with the use of burndown herbicides with the help of nutrients which causes systemic herbicidal effect. The aqueous herbicidal composition comprising of nutrients are absorbed by plants in excess so as to induce phytotoxicity and completely irradicate the undesired plant species from the soil surface. The present invention essentially requires organic acids to alter the pH of the aqueous herbicidal composition which is essential for absorption of nutrients on the plant surface and minimizes burning of the plant surface tissues. These applications are silent on disclosure of specific combination of choline salt of pelargonic acid with elemental sulphur.

Thus, no pesticidal composition comprising specific combination of elemental sulphur and choline salt of pelargonic acid is known or available which can be effectively used at lower dosage and address the limitations as observed with the known compositions.

The inventors of the present invention surprisingly developed a novel pesticidal composition comprising elemental sulphur and choline salt of pelargonic acid in an effective amount which is synergistic in nature and demonstrates excellent field efficacy. The inventors have found that a synergistic composition comprising elemental sulphur and choline salt of pelargonic acid is not only an organic solution but also is a sustainable and ecological solution to the users. The pesticidal composition act as a superior crop-protectant, non-phytotoxic, effective at a lower dosage, reduces application of chemical crop protection agents, and help in resistance management.

In addition to the synergistic effect of the composition of the present invention, the inventors surprisingly determined that the composition comprising elemental sulphur and choline salt of pelargonic acid in an effective amount in the form of liquid or granules or powders provides protection against plant pathogens and improves yield when the particles in the composition are present in the size range of 0.1 micron to 50 microns.

The inventors found that such organic, ecological combination of elemental sulphur and choline salt of pelargonic acid in an effective amount helps to minimize the loss of actives and provides a stable, user friendly formulation. The pesticidal combination with a particle size in the range of 0.1 micron to 50 microns also enhances the physical nature of the formulation by providing improved suspensibility, dispersibility, viscosity and pourability on application via soil or foliar route which provides effective control of target pathogens.

Thus, researchers of the present invention have developed a stable pesticidal composition comprising elemental sulphur in the range of 1% w/w to 95% w/w of the total composition; choline salt of pelargonic acid present in the range of 0.01% w/w to 50% w/w of the total composition; and at least one agrochemically acceptable excipient. The composition have particles in the size range of 0.1 to 50 microns. The pesticidal composition is synergistic and provides surprising results not only as a crop protection agent but also as a yield enhancer. Furthermore, the present composition is superior composition which is difficult to achieve in cost-effective manner, environmentally friendly and is not expected to have adverse effects on humans, non-target organisms or the environment.

### 3. SUMMARY OF THE INVENTION

The invention relates to a pesticidal composition, comprising elemental sulphur; choline salt of pelargonic acid; and at least one agrochemically acceptable excipient.

The present invention relates to a pesticidal composition comprising elemental sulphur in the range of 1% w/w to 95% w/w of the total composition; choline salt of pelargonic acid present in the range of 0.01% w/w to 50% w/w of the total composition; and at least one agrochemically acceptable excipient.

Further, the pesticidal composition is in the form of solid or liquid or gel and comprises particles in the size range of 0.1 micron to 50 microns.

The pesticidal composition is in the form of wettable powder, water dispersible granules, broadcast granules or water disintegrable granules or spheronised granules, liquid suspension or suspension concentrate, oil dispersion, suspoemulsion, flowable concentrate, combination of capsulated suspension and suspension concentrate (ZC).

The invention also relates to a process for preparing the pesticidal composition comprising elemental sulphur in the range of 1% w/w to 95% w/w of the total composition; choline salt of pelargonic acid in the range of 0.01% w/w to 50% w/w of the total composition; and at least one agrochemically acceptable excipient.

According to another embodiment, the invention also relates to a method of protection of crop or improving the crop health and growth, enhancing crop yield, strengthening the plant, increasing crop defense, herbicidal effect; the method comprises treating at least one of seeds, seedling, crops, a plant, plant propagation material, locus, parts thereof or to the surrounding soil with effective amount of the pesticidal composition which includes elemental sulphur and with choline salt of pelargonic acid; with at least one agrochemical excipient.

It was further observed that the agrochemical composition of the present invention exhibits superior physical characteristics such as suspensibility, dispersibility, wettability, viscosity, pourability and stability towards heat, light, temperature, caking etc. The compositions of the present invention also demonstrated superior performance under accelerated storage conditions.

### 4. DETAILED DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

The terms “a” or “an”, as used herein, are defined as one or more than one. The terms “including” and/or “having”, as used herein, are defined as comprising (i.e., open language).

Sulphur used in the composition refers to elemental sulphur.

The term ‘Pelargonic acid’ can be interchangeably used with nonylic acid, nonanoic acid or octane-carboxylic acid or 1-octanecarboxylic acid or C9 fatty acid.

The term ‘Choline salt of pelargonic acid’ includes choline pelargonate, acetyl choline pelargonate.

A water dispersible granule is defined as a formulation which disperses or dissolves rapidly when added to water to give a fine particle suspension. As described herein, “WG” or “WDG” refer to water dispersible granules. Water-dispersible granules are formulated as small, easily measured granules (an agglomeration of fine particles) by blending and agglomerating a ground solid active ingredient together with surfactants and other formulation ingredients which break apart and disperse into finer/primary particles when immersed in water.

According to the invention, the term liquid suspension encompasses “aqueous suspension” or aqueous dispersion” or “suspension concentrates (SC)” or “suspoemulsion (SE)” composition. Liquid suspension can be defined as composition wherein solid particles are dispersed or suspended in a liquid. The liquid as a vehicle can be water and/or a water miscible solvent.

As defined herein, WP refers to a wettable powder, which can be a powder formulation to be applied as a suspension after dispersion in water.

As defined herein, SE refers to a suspoemulsion which is a combination of suspension concentrate (SC) and concentrated aqueous emulsion (EW) technologies.

As described herein, ZC refers to a stable suspension of capsules and an active ingredient in a liquid, normally intended for dilution with water before use.

As defined herein, OD refers to oil dispersion or oil suspension wherein a solid active ingredient is dispersed in oil. The oil can vary from paraffinic to aromatic solvent types and vegetable oil or methylated seed oils.

The present invention relates to a pesticidal composition comprising elemental sulphur, choline salt of pelargonic acid, and at least one agrochemically acceptable excipient.

The present invention relates to a pesticidal composition comprising elemental sulphur present in the range of 1% w/w to 95% w/w of the total composition, choline salt of pelargonic acid present in the range of 0.01% w/w to 50% w/w of the total composition, and at least one agrochemically acceptable excipient.

According to an embodiment, elemental sulphur is present in the range of 1% w/w to 95% w/w of the total composition. According to an embodiment, elemental sulphur is present in the range of 1% w/w to 90% w/w of the total composition. According to an embodiment, elemental sulphur is present in the range of 1% w/w to 85% w/w of the total composition. According to an embodiment, elemental sulphur is present in the range of 1% w/w to 80% w/w of the total composition. According to an embodiment, elemental sulphur is present in the range of 1% w/w to 70% w/w of the total composition. According to an embodiment, elemental sulphur is present in the range of 1% w/w to 60% w/w of the total composition. According to an embodiment, elemental sulphur is present in the range of 10% w/w to 95% w/w of the total composition. According to an embodiment, elemental sulphur is present in the range of 10% w/w to 90% w/w of the total composition. According to an embodiment, elemental sulphur is present in the range of 10% w/w to 80% w/w of the total composition. According to an embodiment, elemental sulphur is present in the range of 10% w/w to 70% w/w of the total composition. According to an embodiment, elemental sulphur is present in the range of 10% w/w to 60% w/w of the total composition. According to an embodiment, elemental sulphur is present in the range of 20% w/w to 95% w/w of the total composition.

According to an embodiment, choline salt of pelargonic acid is choline pelargonate, acetyl choline pelargonate or mixtures thereof. However, those skilled in the art will appreciate that it is possible to utilize other choline salts of pelargonic acid salts or their derivatives known in the art without departing from the scope of the invention.

According to an embodiment, choline salt of pelargonic acid is present in the range of 0.01% to 50% w/w of the total composition. According to an embodiment choline salt of pelargonic acid is present in the range of 0.01% to 40% w/w of the total composition. According to an embodiment, choline salt of pelargonic acid is present in the range of 0.01% to 30% w/w of the total composition. According to an embodiment, choline salt of pelargonic acid is present in the range of 0.01% to 20% w/w of the total composition. According to an embodiment, choline salt of pelargonic acid is present in the range of 0.01% to 15% w/w of the total composition. According to an embodiment, choline salt of pelargonic acid is present in the range of 0.01% to 10% w/w of the total composition

According to an embodiment, the pesticidal composition is in the form of a solid or a liquid or a gel or a paste.

According to an embodiment, the solid pesticidal composition includes powder, granules, dust. According to an embodiment, the pesticidal composition in the form of powder includes wettable powder and dispersible powder. According to an embodiment, the pesticidal composition in the form of granules includes broadcast granule or spheronised granule or water disintegrable granule, pellet, water dispersible granule. According to an embodiment, the solid pesticidal composition particularly includes wettable powder, water dispersible granule, spheronised granule or broadcast granule or water disintegrable granule.

According to an embodiment, the liquid pesticidal composition includes suspension, oil dispersion, liquid suspension or suspension concentrates, flowable concentrate, seed dressing, suspo-emulsion, combination of capsulated suspension and suspension concentrate (ZC). According to an embodiment, the liquid pesticidal composition particularly includes liquid suspension.

According to an embodiment, the particle size of the pesticidal composition is in the range of 0.1 micron to 50 microns. According to further embodiment, the particle size of the pesticidal composition is in the range of 0.1 micron to 40 microns. According to further embodiment, the particle size of the pesticidal composition is in the range of 0.1 micron to 30 microns. According to further embodiment, the particle size of the pesticidal composition is in the range of 0.1 micron to 25 microns. According to further embodiment, the particle size of the pesticidal composition is in the range of 0.1 micron to 20 microns. According to further embodiment, the particle size of the pesticidal composition is in the range of 0.1 micron to 15 microns. According to further embodiment, the particle size of the pesticidal composition is in the range of 0.1 micron to 10 microns.

According to an embodiment, the pesticidal composition in the form of spheronised granules or broadcast granules or water disintegrable granules, wherein the granules are in the size range of 0.1 to 6 mm. According to an embodiment, the granules are in the size range of 0.1 to 5 mm. According to an embodiment, the granules are in the size range 0.1 to 4 mm. According to an embodiment, the granules are in the size range 0.1 to 3 mm. According to an embodiment, the granules are in the size range 0.1 to 2.5 mm.

According to an embodiment, the pesticidal composition is in the form of water dispersible granules, wherein the granules are in the size range of 0.1 to 2.5 mm. According to a further embodiment, the granules are in the size range of 0.1 to 2.0 mm. According to an embodiment, the granules are in the size range of 0.1 to 1.5 mm. According to an embodiment, the granules are in the size range of 0.1 to 1 mm. According to an embodiment, the granules are in the size range of 0.1 to 0.5 mm.

According to an embodiment, the granules disperse into particles in the size range of 0.1 micron to 50 microns. According to an embodiment, the granules disperse into particles in the size range of 0.1 micron to 40 microns. According to an embodiment, the granules disperse into particles in the size range of 0.1 micron to microns. According to an embodiment, the granules disperse into particles in the size range of 0.1 micron to 25 microns. According to an embodiment, the granules disperse into particles in the size range of 0.1 micron to 20 microns. According to an embodiment, the granules disperse into particles in the size range of 0.1 micron to 15 microns. According to an embodiment, the granules disperse into particles in the size range of 0.1 micron to 10 microns.

According to an embodiment, the pesticidal composition comprises at least one agrochemically acceptable excipient. According to further embodiment, the agrochemically acceptable excipient comprises at least one of surfactants, binders or binding agents, wetting agent, emulsifiers, disintegrating agents, fillers or carriers or diluents, coating agents, buffers or pH adjusters or neutralizing agents, antifoaming agents or defoamers, penetrants, ultraviolet absorbents, UV ray scattering agents, stabilizers, pigments, colorants, structuring agents, chelating or complexing or sesquitering agents, thickeners, suspending agents or suspension aid agents or anticaking agents or anti-settling agents, viscosity modifiers or rheology modifiers, tackifiers, humectants, sticking agents, anti-freezing agent or freeze point depressants, solvents include water immiscible solvents or water miscible solvents; and mixtures thereof. However, those skilled in the art will appreciate that it is possible to utilize additional agrochemically acceptable excipients without departing from the scope of the present invention.

According to an embodiment, the pesticidal composition in the form of water dispersible or spheronised granules further comprises at least one agrochemical excipient which includes disintegrating agent, surfactant, binders or fillers or carriers or diluent, antifoaming agent, ultraviolet absorbents, UV ray scattering agents, anticaking agent or antisettling or suspension aid or suspending agent, penetrating agent, sticking agent, tackifier, pigments, colorants, stabilizers. However, those skilled in the art will appreciate that it is possible to utilize additional agrochemically acceptable excipients without departing from the scope of the present invention.

According to an embodiment, the liquid pesticidal composition further comprises at least one agrochemical excipient which includes at least one structuring agent, surfactant, humectants, solvents, suspending agents or suspension aid or anticaking agent or antisettling, penetrating agent, sticking agents, ultraviolet absorbents, UV ray scattering agents, buffer or pH adjuster or neutralizing agent, stabilizer, antifreezing agent or freeze point depressants, antifoaming agents. However, those skilled in the art will appreciate that it is possible to utilize additional agrochemically acceptable excipients without departing from the scope of the present invention.

According to an embodiment, the agrochemically acceptable excipient is present in the range of from 1% w/w to 99% w/w of the total composition. According to an embodiment, the agrochemically acceptable excipient is present in the range of from 5% w/w to 99% w/w of the total composition. According to an embodiment, the agrochemically acceptable excipient is present in the range of from 10% w/w to 99% w/w of the total composition. According to an embodiment, the agrochemically acceptable excipient is present in the range of from 1% w/w to 90% w/w of the total composition. According to an embodiment, the agrochemically acceptable excipient is present in the range of from 1% w/w to 80% w/w of the total composition. According to an embodiment, the agrochemically acceptable excipient is present in the range of from 1% w/w to 70% w/w of the total composition. According to an embodiment, the agrochemically acceptable excipient is present in the range of from 1% w/w to 60% w/w of the total composition. According to an embodiment, the agrochemically acceptable excipient is present in the range of from 1% w/w to 50% w/w of the total composition. According to an embodiment, the agrochemically acceptable excipient is present in the range of from 1% w/w to 40% w/w of the total composition. According to an embodiment, the agrochemically acceptable excipient is present in the range of from 1% w/w to 30% w/w of the total composition.

According to an embodiment, the surfactants which are used in the pesticidal composition include one or more of anionic, cationic, non-ionic, amphoteric and polymeric surfactants. According to an embodiment, the surfactants include one or more of emulsifiers, wetting agents and dispersing agents.

The anionic surfactants include one or more of, but not limited to a salt of fatty acid, a benzoate, a polycarboxylate, a salt of alkylsulfuric acid ester, alkyl ether sulfates, an alkyl sulfate, an alkylaryl sulfate, an alkyl diglycol ether sulfate, a salt of alcohol sulfuric acid ester, an alkyl sulfonate, an alkylaryl sulfonate, a lignin sulfonate, an alkyldiphenyletherdisulfonate, a polystyrene sulfonate, a salt of alkylphosphoric acid ester, an alkylaryl phosphate, styrylaryl hydroxyl phosphate or their derivatives, a styrylaryl phosphate, docusates, a salt of polyoxyethylene alkyl ether sulfuric acid ester, a polyoxyethylenealkylaryl ether sulfate, alkyl sarcosinates, alpha olefin sulfonate sodium salt, alkyl benzene sulfonate or its salts, sodium lauroylsarcosinate, sulfosuccinates, polyacrylates, salts of polyacrylates, salt of polyoxyethylenealkylaryl ether sulfuric acid ester, a polyoxyethylene alkyl ether phosphate, a salt of polyoxyethylenealkylaryl phosphoric acid ester, sulfosuccinates-mono and other diesters, phosphate esters, alkyl naphthalene sulfonates such as isopropyl and butyl derivatives, alkyl ether sulfates—sodium and ammonium salts; alkyl aryl ether phosphates, a salt of polyoxyethylene aryl ether phosphoric acid ester, mono-alkyl sulphosuccinates, aromatic hydrocarbon sulphonates, 2-acrylamido-2-methylpropane sulfonic acid, ammonium lauryl sulfate, ammonium perfluorononanoate, Disodium cocoamphodiacetate, Magnesium laureth sulfate, Perfluorobutanesulfonic acid, Perfluorononanoic acid, carboxylates, Perfluorooctanesulfonic acid, Perfluorooctanoic acid, Phospholipid, Potassium lauryl sulfate, Soap, Soap substitute, Sodium alkyl sulfate, Sodium dodecyl sulfate, Sodium dodecylbenzenesulfonate, Sodium laurate, Sodium laureth sulfate, Sodium lauroylsarcosinate, Sodium myreth sulfate, Sodium nonanoyloxybenzenesulfonate, Sodium pareth sulfate, alkyl carboxylates, Sodium stearate, alpha olefin sulphonates, naphthalene sulfonate salts, alkyl naphthalene sulfonate fatty acid salts, naphthalene sulfonate condensates-sodium salt, fluoro carboxylate, fatty alcohol sulphates, alkyl naphthalene sulfonate condensates-sodium salt, a naphthalene sulfonic acid condensed with formaldehyde or a salt of alkylnaphthalene sulfonic acid condensed with formaldehyde; or salts, derivatives thereof.

Cationic surfactants include one or more of, but not limited to Dialkyl dimethyl ammonium chlorides, Alkyl methyl ethoxylated ammonium chlorides or salts, Dodecyl-, Coco-, Hexadecyl-, Octadecyl-, Octadecyl/Behenyl-, Behenyl-, Cocoamidopropyl-, Trimethyl Ammonium Chloride; Coco-, Stearyl-, bis(2-hydroxyethyl)Methyl Ammonium Chloride, Benzalkonium Chloride, Alkyl-, Tetradecyl-, Octadecyl-Dimethyl Benzyl Ammonium Chloride, Dioctyl-, Di(Octyl-Decyl)-, Didecyl-, Dihexadecyl-Distearyl-, Di(Hydrogenated Tallow)-Dimethyl Ammonium Chloride, Di(Hydrogenated Tallow) Benzyl-, Trioctyl-, Tri(Octyl-Decyl)-, Tridodecyl-, Trihexadecyl-Methyl Ammonium Chloride, Dodecyl Trimethyl-, Dodecyl Dimethyl Benzyl-, Di-(Octyl-Decyl) Dimethyl, Didecyl Dimethyl-Ammonium Bromide, quaternised amine ethoxylates, Behentrimonium chloride, Benzalkonium chloride, Benzethonium chloride, Benzododecinium bromide, Bronidox, quaternary ammonium salts Carbethopendecinium bromide, Cetalkonium chloride, Cetrimonium bromide, Cetrimonium chloride, Cetylpyridinium chloride, Didecyldimethylammonium chloride, Dimethyldioctadecylammonium bromide, Dimethyldioctadecylammonium chloride, Domiphen bromide, Lauryl methyl gluceth-10 hydroxypropyldimonium chloride, Octenidinedihydrochloride, Olaflur, N-Oleyl-1,3-propanediamine, Pahutoxin, Stearalkonium chloride, Tetramethylammonium hydroxide, Thonzonium bromide; salts or derivatives therof.

The non-ionic surfactants include one or more of but not limited to polyol esters, polyol fatty acid esters, polyethoxylated esters, polyethoxylated alcohols, ethoxylated and propoxylated fatty alcohols, ethoxylated and propoxylated alcohols, EO/PO copolymers; EO and PO block copolymers, di, tri-block copolymers; block copolymers of polyethylene glycol and polypropylene glycol, poloxamers, polysorbates, alkyl polysaccharides such as alkyl polyglycosides and blends thereof, amine ethoxylates, sorbitan fatty acid ester, glycol and glycerol esters, glucosidyl alkyl ethers, polyoxyethylene glycol, sorbitan alkyl esters, sorbitan derivatives, fatty acid esters of sorbitan (Spans) and their ethoxylated derivatives (Tweens), and sucrose esters of fatty acids, Cetostearyl alcohol, Cetyl alcohol, Decyl glucoside, Decylpolyglucose, Glycerol monostearate, Lauryl glucoside, Maltosides, Monolaurin, Narrow-range ethoxylate, Nonidet P-40, Nonoxynol-9, Nonoxynols, Octaethylene glycol monododecyl ether, N-Octyl beta-D-thioglucopyranoside, Octyl glucoside, Oleyl alcohol, PEG-10 sunflower glycerides, Pentaethylene glycol monododecyl ether, Polidocanol, Poloxamer, Poloxamer 407, Polyethoxylated tallow amine, Polyglycerol polyricinoleate, Polysorbate, Polysorbate 20, Polysorbate 80, Sorbitan derivatives, Sorbitan monolaurate, Sorbitanmonostearate, Sorbitantristearate, Stearyl alcohol, glyceryl laureate, lauryl glucoside, nonylphenolpolyethoxyethanols, nonyl phenol polyglycol ether, castor oil ethoxylate, polyglycol ethers, polyadducts of ethylene oxide and propylene oxide, block copolymer of polyalkylene glycol ether and hydroxystearic acid, tributylphenoxypolyethoxy ethanol, octylphenoxypolyethoxy ethanol, etho-propoxylatedtristyrlphenols, ethoxylated alcohols, polyoxy ethylene sorbitan, fatty acid polyglyceride, a fatty acid alcohol polyglycol ether, an oxyalkylene block polymer, a polyoxyethylene alkyl ether, a polyoxyethylenealkylaryl ether, a polyoxyethylenestyrylaryl ether, a polyoxyethylene glycol alkyl ether, polyethylene glycol, a polyoxyethylene fatty acid ester, a polyoxyethylenesorbitan fatty acid ester, a polyoxyethylene glycerin fatty acid ester, Alcohol ethoxylates—C6 to C16/18 alcohols, linear and branched, Alcohol alkoxylates—various hydrophobes and EO/PO contents and ratios, Fatty acid esters—mono and diesters; lauric, stearic and oleic; Glycerol esters—with and without EO; lauric, stearic, cocoa and tall oil derived, Ethoxylated glycerine, Sorbitan esters—with and without EO; lauric, stearic and oleic based; mono and triesters, Castor oil ethoxylates—5 to 200 moles EO; non-hydrogenated and hydrogenated, Block polymers, Amine oxides-ethoxylated and non-ethoxylated; alkyl dimethyl, Fatty amine ethoxylates—coco, tallow, stearyl, oleyl amines, a polyoxyethylene hydrogenated castor oil or a polyoxypropylene fatty acid ester; salts or derivatives thereof.

Amphoteric or Zwitterionic surfactants include one or more of, but not limited to one or more of betaine, coco and lauryl amidopropyl betaines, Coco Alkyl Dimethyl Amine Oxides, alkyl dimethyl betaines; C8 to C18, Alkyl dipropionates-sodium lauriminodipropionate, Cocoamidopropylhydroxysulfobetaine, imidazolines, phospholipids phosphatidylserine, phosphatidylethanolamine, phosphatidylcholine, and sphingomyelins, Lauryl Dimethylamine Oxide, alkyl amphoacetates and proprionates, alkyl Ampho(di)acetates, and diproprionates, lecithin and ethanolamine fatty amides; or salts, derivatives thereof.

Surfactants that are commercially available under the trademark but are not limited to one or more of Atlas G5000, TERMUL 5429, TERMUL 2510, ECOTERIC®, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, Cetomacrogol 1000, CHEMONIC OE-20, Triton N-101, Triton X-100, Tween 20, 40, 60, 65, 80, Span20, 40, 60, 80, 83, 85, 120, Brij®, Atlox 4912, Atlas G5000, TERMUL 3512, TERMUL 3015, TERMUL 5429, TERMUL 2510, ECOTERIC®, ECOTERIC® T85, ECOTERIC® T20, TERIC 12A4, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, IGEPAL CA-630 and Isoceteth-20.

However, those skilled in the art will appreciate that it is possible to utilize other conventionally known surfactants without departing from the scope of the present invention. The surfactants are commercially manufactured and available through various companies.

According to an embodiment, the surfactant is present in an amount of 0.1% to 60% w/w of the total composition. According to an embodiment, the surfactant is present in an amount of 0.1% to 40% w/w of the total composition. According to an embodiment; the surfactant is present in an amount of 0.1% to 30% w/w of the total composition. According to a further embodiment, the surfactant is present in an amount of 0.1% to 20% w/w of the total composition. According to an embodiment, the surfactant is present in an amount of 0.1% to 10% w/w of the total composition.

According to an embodiment, the dispersing agents which are used in the pesticidal composition includes, but not limited to one or more of polyvinyl alcohol, phenol naphthalene sulphonates, lignin sulphonates, lignin derivatives, dibutylnaphthalene-sulfonic acid, alkylarylsulfonates, alkyl sulfates, alkylsulfonates, fatty alcohol sulfates, fatty acids and sulfated fatty alcohol glycol ethers, polyoxyethylene alkyl ethers, dioctyl sulfosuccinate, lauryl sulfate, polyoxyethylenestyryl phenyl ether sulfate ester salts and the like, alkali metal salts thereof, ammonium salts or amine salts, polyoxyethylenestyryl phenyl ether, polyoxyethylenesorbitan alkyl esters, and the like, mixture of sodium salt of naphthalene sulphonic acid urea formaldehyde condensate and sodium salt of phenol sulphonic formaldehyde condensate ethoxylated alkyl phenols, ethoxylated fatty acids, alkoxylated linear alcohols, polyaromatic sulfonates, sodium alkyl aryl sulfonates, glyceryl esters, ammonium salts of maleic anhydride copolymers, phosphate esters, salts of addition products of ethylene oxide and fatty acid esters, polycarboxylates, sodium salts of condensed phenolsulfonic acid as well as the napthalene sulfonate-formaldehyde condensates, sodium naphthalene sulfonate formaldehyde condensates, ammonium salts of sulfonated naphthalene, salts of polyacrylic acids, tristyrylphenolethoxylate phosphate esters; aliphatic alcohol ethoxylates; alkyl ethoxylates; EO-PO block copolymers; graft copolymers, ammonium salts of sulfonated naphthalene, salts of polyacrylic acids, salts, derivatives thereof, Poly methyl methacrylate/Acrylic Graft co-polymer and its derivatives, Nonyl-phenol ethoxylates and its derivatives, Castor oil based ethoxylates, sorbitan ester ethoxylates, Lanolin alcohol ethoxylates, Polyol ethoxylates, Phosphate esters and its derivatives, stearic fatty acids and its derivatives, oleic fatty acids, vegetable fatty acids, tallow fatty acids ethoxylates,

Commercially available dispersing agents include “Morwet D425” (sodium naphthalene formaldehyde condensate ex Nouryon Corporation, USA) “Morwet EFW” Sulfated Alkyl Carboxylate and Alkyl Naphthalene Sulfonate-Sodium Salt “Tamol PP” (sodium salt of a phenolsulphonic acid condensate) “Reax 80N” (sodium lignosulphonate) “Wettol D1” sodium alkylnaphthalene sulphonate (ex BASF). However, those skilled in the art will appreciate that it is possible to utilize other conventionally known dispersants without departing from the scope of the present invention. The dispersing agents are commercially manufactured and available through various companies.

According to an embodiment, the dispersing agent is present in an amount of 0.1-60% w/w of the total composition. According to an embodiment, the dispersing agent is present in an amount of 0.1-30% w/w of the total composition. According to an embodiment, the dispersing agent is present in an amount of 3-20% w/w of the total composition.

According to an embodiment the wetting agents used in the pesticidal composition include, but not limited to one or more of phenol naphthalene sulphonates, alkyl naphthalene sulfonate and their salts, sodium alkyl naphthalene sulfonate, sodium salt of sulfonated alkylcarboxylate, polyoxyalkylated ethyl phenols, polyoxyethoxylated fatty alcohols, polyoxyethoxylated fatty amines, lignin derivatives, alkane sulfonates or their salts, alkylbenzene sulfonates, salts of polycarboxylic acids, salts of esters of sulfosuccinic acid, alkylpolyglycol ether sulfonates, alkyl ether phosphates, alkyl ether sulphates and alkyl sulfosuccinic monoesters, Alkyl polyglucoside, Alkyl polysaccharide, or their salts or derivatives thereof. However, those skilled in the art will appreciate that it is possible to utilize other conventionally known wetting agents without departing from the scope of the present invention. The wetting agents are commercially manufactured and available through various companies.

According to an embodiment, the wetting agent is present in an amount of 0.1%-60% w/w of the total composition. According to an embodiment, the wetting agent is present in an amount of 0.1%-40% w/w of the total composition. According to an embodiment, the wetting agent is present in an amount of 0.1%-30% w/w of the total composition.

According to an embodiment the emulsifiers used in the pesticidal composition include, but not limited to one or more of, alkylated benzene sulphonates, ethoxylated or alkoxylated tristyrylphenols, alkoxylated coplymers, fatty alcohol ethoxylates, fatty acid derivatives, sorbitol derivatives, castor oil ethoxylates and derivatives, ethoxylated phenols, ethoxylated alkylphenols, nonylphenol alkoxylates, alcohol alkoxylates, sulphosuccinates, alkyletherphosphates, alkoxylated fatty alcohol phosphates (e.g. PEG 10 PPG 5 Cetyl phosphate), polyvinyl alcohol, PVP, lignin sulfonate, Poly acrylates, polysorbates, polycarboxylates, alcohol ethoxylates, salt of alkyl aryl sulphonates derivative thereof. However, those skilled in the art will appreciate that it is possible to utilize other conventionally known wetting agents without departing from the scope of the present invention. The emulsifiers are commercially manufactured and available through various companies.

Emulsifiers which are used in the pesticidal composition include but are not limited one or more of Atlas G5000, TERMUL 5429, TERMUL 2510, ECOTERIC®, EMULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, Tween 20, 40, 60, 65, 80, Span20, 40, 60, 80, 83, 85, 120, Brij®, Triton™ Atlox 4912, Atlas G5000, TERMUL 3512, TERMUL 3015, TERMUL 5429, TERMUL 2510, ECOTERIC®, ECOTERIC® T85, ECOTERIC® T20, TERIC 12A4, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, Tween 20, 40, 60, 65, 80 and Span 20, 40, 60, 80, 83, 85, 120 can also be used. However, those skilled in the art will appreciate that it is possible to utilize other conventionally known emulsifiers without departing from the scope of the present invention. The emulsifiers are commercially manufactured and available through various companies.

According to an embodiment, the emulsifier is present in an amount of 0.1%-60% w/w of the total composition. According to an embodiment, the emulsifier is present in an amount of 0.1%-50% w/w of the total composition. According to an embodiment, the emulsifier is present in an amount of 0.1%-30% w/w of the total composition.

According to an embodiment, the solvents used in the pesticidal composition include water miscible solvents or water immiscible solvents.

The water miscible solvents include, but are not limited to Ethylene glycol, Glycerol, N-Methyl-2-pyrrolidone, 1,3-Propanediol, 1,5-Pentanediol, Propylene glycol, Triethylene glycol, 1,2-Butanediol, 1,3-Butanediol, 1,4-Butanediol, Dimethylformamide, Decainamide, Dimethoxyethane, Dimethyloctanamide, Dimethyldecanamide, Water, Propylene glycol, monoethylene glycol, poly ethylene glycol ether and its derivatives, glycerol, Sorbitol, Dimethyloctanamide, Dimethyldecanamide, Dimethyloctadecanamide, Monobutyl ether, in general glycols and glycol ethers, alkylene carbonates, n-methyl pyrrolidone, Dimethylformamide, Acetophenone, Cyclohexanone, dimethyl sulfoxide. However, those skilled in the art will appreciate that it is possible to utilize other water miscible solvents without departing from the scope of the present invention.

According to an embodiment, the solvent is present in an amount of 0.1-95% w/w of the total composition. According to an embodiment, the solvent is present in an amount of 0.1-60% w/w of the total composition. According to an embodiment, the solvent is present in an amount of 0.1-40% w/w of the total composition. According to an embodiment, the solvent is present in an amount of 0.1-30% w/w of the total composition.

According to an embodiment, the disintegrating agents which are used in the pesticidal composition include, but not limited to one or more of inorganic water soluble salts of sodium, potassium, magnesium, ammonium, nitrate, acetate e.g. sodium chloride, potassium chloride, potassium nitrate; water insoluble organic compounds such as microcrystalline cellulose, cross-linked sodium carboxymethyl cellulose, carboxymethyl calcium, cellulose powder; sodium tripolyphosphate, sodium hexametaphosphate, metal stearates, dextrin, methacrylate copolymer, Polyplasdone® XL-10 (crosslinked polyvinylpyrrolidone), polyaminocarboxylic acid, sulfonated styrene-isobutylene-maleic anhydride copolymer, salts of polyacrylates or methacrylates, starch-polyacrylonitrile graft copolymer, sodium or potassium bicarbonates/carbonates or their mixtures or salts with acids such as citric and fumaric acid, or salts, phenol naphthalene sulphonates, alkyl naphthalene sulfonate, sodium alkyl naphthalene sulfonate, sodium salt of sulfonated alkylcarboxylate, polyoxyalkylated ethyl phenols, polyoxyethoxylated fatty alcohols, polyoxyethoxylated fatty amines, lignin derivatives, alkane sulfonates, alkylbenzene sulfonates, salts of polycarboxylic acids, salts of esters of sulfosuccinic acid, alkylpolyglycol ether sulfonates, alkyl ether phosphates, alkyl ether sulphates and alkyl sulfosuccinic monoesters, lignosulphonates, salts derivatives thereof. However, those skilled in the art will appreciate that it is possible to utilize different disintegrating agents without departing from the scope of the present invention. The disintegrating agents are commercially manufactured and available through various companies.

According to an embodiment, the disintegrating agent is present in an amount of 0.1% to 50% w/w of the composition. According to an embodiment, the disintegrating agent is present in an amount of 0.1% to 30% w/w of the composition. According to an embodiment, the disintegrating agent is present in an amount of 0.1% to 20% w/w of the composition. According to an embodiment, the disintegrating agent is present in an amount of 0.1% to 10% w/w of the composition.

According to an embodiment, the binding agents or binders which are used in the pesticidal composition, but not limited to one or more of polyvinylalcohol, lactose, polyvinylyrrolidone, water soluble cellulose derivatives such as carboxymethyl cellulose, methyl cellulose, Starch, dextrins, lignin sulphonates and bentonite, carbohydrates such as monosaccharides, disaccharides, oligosaccharides and polysaccharides, clays, kaolins, attapulgite, xanthan gum, guar gum, Carrageenan, poly acrylates, poly carboxylates, carbomers, derivatives and combinations thereof. However, those skilled in the art will appreciate that it is possible to utilize different binding agents without departing from the scope of the present invention. The binding agents are commercially manufactured and available through various companies.

According to an embodiment, the binding agent is present in an amount of 0.1% to 50% w/w of the composition. According to further embodiment, the binding agent is present in an amount of 0.1% to 30% w/w of the composition. According to further embodiment, the binding agent is present in an amount of 0.1% to 20% w/w of the composition. According to further embodiment, the binding agent is present in an amount of 0.1% to 10% w/w of the composition.

According to an embodiment, the carriers which are used in the pesticidal composition include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention. The carriers are commercially manufactured and available through various companies.

The solid carriers include natural minerals like clay such as bentonite, china clay, acid clay, dolomite, kaolin such as kaolinite, dickite, nacrite, and halloysite, synthetic and diatomaceous silicas, montmorillonite minerals such as sodium montmorillonite, smectites, such as saponite, hectorite, sauconite, and hyderite, micas, such as pyrophyllite, talc, agalmatolite, muscovite, phengite, sericite, and illite, silicas such as cristobalite, attapulgite, sepiolite; vermiculite, laponite, pumice, perlite, volclay, vermiculites, limestone, natural and synthetic silicates, charcoal, silica, powdered silica, fused silica, hydrophobic silica, wet process silicas, dry process silicas, calcined products of wet process silicas, surface-modified silicas, mica, zeolite, diatomaceous earth, derivatives thereof; fly ash, chalks (Omya®), fuller's earth, loess, mirabilite, white carbon, slaked lime, synthetic silicic acid, starch, modified starch (Pineflow, available from Matsutani Chemical industry Co., Ltd.), sucrose, potassium pyrophosphate, sodium tripolyphosphate, kaolin 1777, Lactose, maltodextrin, dextrin, sorbitol; salts of lignin sulphonates such as ammonium, sodium, calcium, zinc. Water insoluble carriers include, but not limited to clays, microcrystalline cellulose, perlite, volcanic ash, mica, calcium or magnesium carbonates, diatomaceous earth, soap stone, starch, hydrophobically or hydrophilically modified starch, calcium phosphates. Water soluble salts such as, Sodium bicarbonate, citrate, nitrate, sulphate, hexametaphosphate, phosphate, Ammonium salts such as sulphate, phosphate, magnesium sulphate. However, those skilled in the art will appreciate that it is possible to utilize different solid carriers without departing from the scope of the present invention. The solid carriers are commercially manufactured and available through various companies.

According to an embodiment, the carrier is present in an amount of 0.1% to 98% w/w of the composition. According to further embodiment, the carrier is present in an amount of 0.1% to 80% w/w of the composition. According to further embodiment, the carrier is present in an amount of 0.1% to 60% w/w of the composition. According to further embodiment, the carrier is present in an amount of 0.1% to 40% w/w of the composition. According to further embodiment, the carrier is present in an amount of 0.1% to 20% w/w of the composition.

According to an embodiment, the anticaking agents which are used in the pesticidal composition include, but are not limited to one or more of precipitated Silica, fumed silica, hydrophobically modified silica, Perlite, Mica, Talc, soapstone, Magnesium Aluminum silicate, clays, Calcium silicate, sodium bicarbonate, Magnesium trisilicate, fumed silica (white carbon), ester gum, a petroleum resin, Foammaster® Soap L sodium stearate, sodium metasilicate, sodium carbonate, Sodium alumino silicates, calcium carbonate and magnesium carbonate, Magnesium stearate, calcium phosphate salts or derivatives thereof. However, those skilled in the art will appreciate that it is possible to utilize different anti caking agents without departing from the scope of the present invention. The anti-caking agents are commercially manufactured and available through various companies.

According to an embodiment, the antifoaming agents or defoamers which are used in the pesticidal composition include, but not limited to one or more of silica, siloxane, silicone dioxide, polydimethyl siloxane and its derivatives, vegetable oils, petroleum oils, paraffin oil, polyethylene glycol, Silicone oils and magnesium stearate or derivatives thereof. Preferred antifoaming agents include silicone emulsions (such as, e.g., Silikon® SRE, Wacker or Rhodorsil® from Rhodia), long-chain alcohols, fatty acids. Non silicone defoamers can also be used. However, those skilled in the art will appreciate that it is possible to utilize other conventionally known antifoaming agents without departing from the scope of the present invention. The antifoaming agents are commercially manufactured and available through various companies.

According to an embodiment, the anti-foaming agent is present in an amount of 0.01% to 20% w/w of the total composition. According to an embodiment, the anti-foaming agent is present in an amount of 0.01% to 10% w/w of the total composition. According to an embodiment, the anti-foaming agent is present in an amount of 0.01% to 5% w/w of the total composition. According to an embodiment, the anti-foaming agent is present in an amount of 0.01% to 1% w/w of the total composition.

According to an embodiment, the pH-adjusters or buffers or neutralizing agents which are used in the pesticidal composition include both acids and bases of the organic or inorganic type and mixtures thereof. According to further embodiment, pH-adjusters or buffers or neutralizing agents include, but not limited to one or more of organic acids, inorganic acids and alkali metal compounds or salts, derivatives thereof. According to an embodiment, the organic acids include, but not limited to one or more of acetic, propionic, citric, oxalic, malic, adipic, fumaric, maleic, succinic, tartaric acid, hydrochloric acid, nitric acid, sulphuric acid, phosphoric acid, boric acid, phytic acid or salts, derivatives thereof; and the mono-, di-, or tribasic salts of these acids or derivatives thereof. Alkali metal compounds include, but not limited to one or more of hydroxides of alkali metals such as sodium hydroxide and potassium hydroxide, carbonates of alkali metals such as sodium carbonate, hydrogencarbonates of alkali metals such as sodium hydrogencarbonate and alkali metal phosphates such as sodium phosphate, sodium dihydrogen phosphate; sodium hydroxide, potassium hydroxide, ammonium hydroxide, Borax, sodium borate; calcium carbonate, calcium hydroxide, ferrous hydroxide, Magnesia, Lime, potassium acetate, potassium bicarbonate, potassium carbonate, sodium acetate, sodium benzoate, sodium carbonate, sodium bicarbonate, sodium metasilicate, trisodium phosphate, ammonia, primary amines, secondary amines and tertiary amines and mixtures thereof. According to an embodiment, the salts of organic acids include, but not limited to one or more of alkali metal salts such as sodium citrate and the like. Mixtures can also be used to create a pH-adjusters or buffers or neutralizing agents. However, those skilled in the art will appreciate that it is possible to utilize other conventionally known pH-adjusters or buffers or neutralizing agents without departing from the scope of the present invention. The pH-adjusters or buffers or neutralizing agents are commercially manufactured and available through various companies.

According to an embodiment, the pH-adjusters or buffers are present in an amount of 0.01% to 20% w/w of the total composition. According to an embodiment, the pH-adjusters or buffers are present in an amount of 0.01% to 10% w/w of the total composition. According to an embodiment, the pH-adjusters or buffers are present in an amount of 0.01% to 5% w/w of the total composition. According to an embodiment, the pH-adjusters or buffers are present in an amount of 0.01% to 1% w/w of the total composition.

According to an embodiment, the spreading agents which are used in the pesticidal composition include, but not limited to one or more of silicone surfactants, copolymer of maleic acid with a styrene compound, a (meth)acrylic acid copolymer, a half ester of a polymer consisting of polyhydric alcohol with dicarboxylic anhydride, a water-soluble salt of polystyrenesulfonic acid, fatty acids, aliphatic alcohols, vegetable oils such as cottonseed, or inorganic oils, petroleum distillates, modified trisiloxanes, polyglycol, polyethers, polyoxyalkylated ethyl phenols, polyoxyethoxylated fatty alcohols, polyoxyethoxylated fatty amines, alkylpolyglycol ether sulfonates, alkyl ether phosphates, Alkyl polyglucoside, Alkyl polysaccharide, vegetable oil, mineral oils, petroleum oils, silicone oils, siloxanes, polyoxyalkylene alkyl ethers, polyoxyalkylene alkylphenyl ethers, polyoxyalkylene polyhydric alcohol fatty acid esters, polyhydric alcohol fatty acid esters, polyoxyalkylene alkylamines, alkyl polyglycosides and glycidyl ethers are preferable. Examples of polyhydric alcohols constituting a nonionic surfactant include divalent alcohols such as ethyleneglycol, 1,2-propyleneglycol, 1,3-propyleneglycol, 1,4-butanediol, 2,3-butanediol, 1,5-pentanediol, 1,6-hexanediol, 1,8-octanediol, neopentyl glycol or 2-methyl-1,3-propanediol, trivalent alcohols such as glycerol, clathrates or salts or derivatives thereof. However, those skilled in the art will appreciate that it is possible to utilize other conventionally known spreading agents without departing from the scope of the present invention. The spreading agents are commercially manufactured and available through various companies.

According to an embodiment, the spreading agent is present in an amount of 0.1% to 20% w/w of the total composition. According to an embodiment, the spreading agent is present in an amount of 0.1% to 10% w/w of the total composition. According to an embodiment, the spreading agent is present in an amount of 0.1% to 5% w/w of the total composition. According to an embodiment, the spreading agent is present in an amount of 0.1% to 1% w/w of the total composition.

According to an embodiment, the sticking agents which are used in the pesticidal composition include, but not limited to one or more of, silicone-based surfactants, mineral oils, vegetable oils, petroleum oil, silicone oils, emulsifiers, fish oil or fatty acid soaps or emulsified vegetable oil. Carboxymethylcellulose and natural and synthetic polymers such as gum arabic, xanthan gum, guar gum, carrageenan, carbomer, polyvinyl alcohol, polyvinyl pyrrolidone and polyvinyl acetate, lecithins, carboxymethyl cellulose, natural and synthetic polymers, paraffin, a polyamide resin, polyacrylate, polyoxyethylene, wax, polyvinyl alkyl ether, an alkylphenol-formalin condensate, fatty acids, aliphatic alcohols, vegetable oils such as cottonseed, or inorganic oils, petroleum distillates, modified trisiloxanes, polyglycol, polyethers, clathrates, a synthetic resin emulsion or salts or derivatives thereof. However, those skilled in the art will appreciate that it is possible to utilize other conventionally known sticking agents without departing from the scope of the present invention. The sticking agents are commercially manufactured and available through various companies. According to an embodiment, the sticking agent can be present in an amount of 0.1% to 30% w/w of the total composition.

According to an embodiment, the sticking agent is present in an amount of 0.1% to 20% w/w of the total composition. According to an embodiment, the sticking agent is present in an amount of 0.1% to 10% w/w of the total composition.

According to an embodiment, the stabilizers which are used in the pesticidal composition include, but not limited to alkyl glyoxylates such as ethyl glyoxylate, zeolite, EDTA and chelating agents, sequestering agents, antioxidants such as sodium bisulphite, sodium metabisulphite, ascorbic acid, citric acid, malic acid and their salts; phenol compounds, and the like; ultraviolet absorbers such as benzophenone compounds or derivatives thereof. However, those skilled in the art will appreciate that it is possible to utilize other conventionally known stabilizers without departing from the scope of the present invention. The stabilizers are commercially manufactured and available through various companies.

According to an embodiment, the stabilizer is present in an amount of 0.1% to 30% w/w of the total composition. According to an embodiment, the stabilizer is present in an amount of 0.1% to 20% w/w of the total composition. According to an embodiment, the stabilizer is present in an amount of 0.1% to 10% w/w of the total composition.

According to an embodiment, the preservatives which are used in the pesticidal composition include but not limited to, one or more of bactericides, anti-fungal agents, biocides, anti-microbial agents, and antioxidant. Non limiting examples of preservatives include one or more of paraben, its esters and salts, propionic acid and its salts, 2,4-hexadienoic acid (sorbic acid) and its salt, formaldehyde and paraformaldehyde, 2-hydroxybiphenyl ether and its salts, inorganic sulfites and bisulfites, sodium iodate, chlorobutanol, 1,6-bis(4-amidino-2-bromophenoxy)-n-hexane and its salts, 5-amino-1,3-bis(2-ethylhexyl)-5-methylhexahydropyrimidine, 5-bromo-5-nitro-1,3-dioxane, 2-bromo-2-nitropropane-1,3-diol, 2,4-dichlorobenzyl alcohol, 5-chloro-2-(2,4-dichlorobenzylalcohol), N-(4-chlorophenyl)-N′-(3,4-dichlorophenyl) urea, 4-chloro-m-cresol, 2,4,4′-trichloro-2′-hydroxy diphenyl ether, 4-chloro-3,5-dimethyl phenol, 1,1′-methylene-bis(3-(1-hydroxy methyl-2,4-dioximidazolidin-5-yl)urea), 2-phenoxyethanol, hexamethylenetetramine, 1-(3-chloroallyl)-3,5,7-triaza-1-azonia-adamantane chloride, 1(4-chlorophenoxy)-1-(1H-imidazol-1-yl)-3,3-dimethyl-2-butanone, 1,3-bis(hydroxymethyl)-5,5-dimethyl-2,4-imidazolidinedione, benzyl alcohol, octopirox, 1,2-dibromo-2,4-dicyanobutane, 2,2′-methylenebis(6-bromo-4-chlorophenol), bromochlorophene, dichlorophene, 2-benzyl-4-chlorophenol, 2-chloroacetamide, chlorhexidine, chlorhexidine acetate, chlorhexidine gluconate, chlorhexidine hydrochloride, 1-phenoxypropan-2-ol, N-alkyl(C12-C22)trimethylammonium bromide and chloride, 4,4-dimethyl-1,3-oxazolidine, N-hydroxymethyl-N-(1,3-di(hydroxymethyl)-2,5-dioxoimidazolidin-4-yl)-N′-hydroxymethylurea, 1,6-bis(4-amidinophenoxy)-n-hexane and its salts, glutaraldehyde, 5-ethyl-1-aza-3,7-dioxabicyclo(3.3.0)octane, 3-(4-chlorophenoxy)propane-1,2-diol, Hyamine, alkyl(C8-C18)dimethylbenzyl ammonium chloride, alkyl(C8-C18)dimethylbenzylammonium bromide, alkyl(C8-C18)dimethylbenzylammonium saccharinate, benzyl hemiformal, 3-iodo-2-propynyl butylcarbamate, sodium hydroxymethylaminoacetate, cetyltrimethylammonium bromide, acetic acid, cetylpyridinium chloride, and derivatives of 2H isothiazol-3-one (so-called isothiazolone derivatives) such as alkylisothiazolones (for example 2-methyl-2H-isothiazol-3-one, MIT; chloro-2-methyl-2H-isothiazol-3-one, CIT), benzoisothiazolones (for example 1,2-benzoisothiazol-3(2H)-one, BIT, commercially available as Proxel® types from ICI) or 2-methyl-4,5-trimethylene-2H-isothiazol-3-one (MTIT), C1-C4-alkyl para-hydroxybenzoate, an dichlorophene, Proxel® from ICI or Acticide® RS from Thor Chemie and Kathon® MK from Rohm & Haas, Bacto-100, Sodium Propinoate, Sodium Benzoate, Propyl Paraben, Propyl Paraben Sodum, Potassium Sorbate, Potassium Benzoate, Phenyl Etehyl Alcohol, Sodium, Ethylparaben, Methylparaben, Butylparaben, Bezyla Alcohol, Benzothonium Chloride, Cetylpyridinium Chloride, Benzalkonium Chloride, 1,2-benzothiazol-3-one, Preventol® (Lanxess®), Butylhydroxytoluene, potassium sorbate, iodine-containing organic compounds such as 3-bromo-2,3-diiodo-2-propenyl ethyl carbonate, 3-iodo-2-propynyl butyl carbamate, 2,3,3-triiodo allyl alcohol, and parachlorophenyl-3-iodopropargylformal; benzimidazole compounds and benzthiazole compounds such as 2-(4-thiazolyl)benzimidazole and 2-thiocyanomethylthiobenzo-thiazole; triazole compounds such as 1-(2-(2′,4′-dichlorophenyl)-1,3-dioxolane-2-ylmethyl)-1H-1,2,4-triazole, 1-(2-(2′,4′-dichloro phenyl)-4-propyl-1,3-dioxolane-2-ylmethyl)-1H-1,2,4-triazole, and α-(2-(4-chlorophenyl) ethyl)-α-(1,1-dimethyl ethyl)-1H-1,2,4-triazole-1-ethanol; and naturally occurring compounds such as 4-isopropyl tropolone (hinokitiol) and borax or salts or derivatives thereof. Antioxidants includes but not limited to one or more of sodium or potassium bisulphites, sulphites, ascorbic acid, isoascorbic acid, imidazole and imidazole derivatives (e.g. urocanic acid), 4,4′-thiobis-6-t-butyl-3-methylphenol, 2,6-di-t-butyl-p-cresol (BHT), and pentaerythrityltetrakis [3-(3,5,-di-t-butyl-4-hydroxyphenyl)]propionate; amine antioxidants such as N,N′-di-2-naphthyl-p-phenylenediamine; hydroquinoline antioxidants such as 2,5-di(t-amyl)hydroquinoline; phosphorus-containing antioxidants such as triphenyl phosphatepropylthiouracil, hydroquinone and derivatives thereof (e.g. arbutin), ubiquinone and ubiquinol, and derivatives thereof, ascorbyl palmitate, stearate, di-palmitate, acetate, Mg ascorbyl phosphates, diso-diumascorbyl phosphate and sulfate, potassium ascorbyltocopheryl phosphate, isoascorbic acid and derivatives thereof, disodium rutinyldisulfate, dibutylhydroxytoluene, 4,4-thiobis-6-tert-butyl-3-methylphenol, butylhydroxy anisole, p-octylphenol, mono-(di- or tri-) methyl benzylphenol, 2,6-tert-butyl-4-methylphenol, pentaerythritol-tetrakis 3-(3,5-di-tert-butyl-4-hydroxyphenyl)propionate, butylhydroxyanisol, trihydroxybutyrophenone, thereof. However, those skilled in the art will appreciate that it is possible to utilize other conventionally known preservatives without departing from the scope of the present invention. The preservatives are commercially manufactured and available through various companies.

According to an embodiment, the preservative or bactericides or anti-fungal agents or biocides or anti-microbial agents or antioxidant is present in an amount of 0.1% to 20% w/w of the total composition. According to further embodiment, the preservative or bactericides or anti-fungal agents or biocides or anti-microbial agents or antioxidant is present in an amount of 0.1% to 10% w/w of the total composition. According to further embodiment, the preservative or bactericides or anti-fungal agents or biocides or anti-microbial agents or antioxidant is present in an amount of 0.1% to 5% w/w of the total composition. According to further embodiment, the preservative or bactericides or anti-fungal agents or biocides or anti-microbial agents or antioxidant is present in an amount of 0.1% to 1% w/w of the total composition.

According to an embodiment, the structuring agents which are used in the pesticidal composition include, but not limited to one or more of thickeners, viscosity modifiers, tackifiers, suspension aids, rheological modifiers or anti-settling agents. A structuring agent prevents sedimentation of the active ingredient particles after prolonged storage.

According to an embodiment, the structuring agents which are used in the composition include, but not limited to one or more polymers such as polyacrylics, polyacrylamides, polysaccharides, modified cellulose derivatives, co-polymers of cellulose derivatives, carboxyvinyl or polyvinyl pyrrolidones, polyethylenes, polyethylene oxide, polyvinyl alcohol and derivatives; clays such as bentonite clays, kaolin, smectite, attapulgites, attaclays, veegum, vangel with high surface area, silica and natural gums such as guar gum, xanthan gum, gum Arabic, gum tragacanth, rhamsan gum, locust bean gum, carrageenan, welan gum, dextrin, polyacrylic acids and their sodium salts; fumed silica, mixture of fumed silica and fumed aluminium oxide, swellable polymers, swelling clay, polyamides or its derivatives; polyols such as poly(vinyl acetate), sodium polyacrylate, poly(ethylene glycol), phospholipid (for example, cephalin, and the like); stachyose, fructo-oligosaccharides, amylose, pectins, alginates, hydrocolloids and mixtures thereof. Also, celluloses such as, carboxymethylcellulose, ethylcellulose, hydroxyethylcellulose, hydroxy-methyl ethyl cellulose, hydroxyl ethyl propyl cellulose, methylhydroxyethylcellulose, methylcellulose; starches, starch acetates, starch hydroxyethyl ethers, ionic starches, long-chain alkyl starches, dextrins, maltodextrin, corn starch, amine starches, phosphates starches, and dialdehyde starches; plant starches such as corn starch and potato starch; other carbohydrates such as pectin, amylopectin, xylan, glycogen, agar, gluten, alginic acid, phycocolloids, chitosan or derivatives thereof. However, those skilled in the art will appreciate that it is possible to utilize other conventionally known structuring agents without departing from the scope of the present invention.

Preferred structuring agents include one or more of xanthan gum, aluminum silicate, methylcellulose, polysaccharide, alkaline earth metal silicate, veegum, bentonite, attapulgite, kaolin and polyvinyl alcohol. The structuring agents are commercially manufactured and available through various companies.

According to an embodiment, the structuring agent is present in an amount of 0.01% to 5% w/w of the composition. According to an embodiment, the structuring agent is present in an amount of 0.01% to 4% w/w of the composition. According to an embodiment, the structuring agent is present in an amount of 0.01% to 3% w/w of the composition. According to an embodiment, the structuring agent is present in an amount of 0.01% to 2% w/w of the composition. According to an embodiment, the structuring agent is present in an amount of 0.01% to 1% w/w of the composition. According to an embodiment, the structuring agent is present in an amount of 0.01% to 0.1% w/w of the composition.

According to an embodiment, the antifreezing agents or freezing point depressants used in the liquid suspension composition include, but are not limited to one or more of polyhydric alcohols such as ethylene glycol, diethylene glycol, dipropylene glycol, propylene glycol, glycerol, monohydric or polyhydric alcohols, glycol ethers, glycol ethers, glycol monoethers such as the methyl, ethyl, propyl and butyl ether of ethylene glycol, diethylene glycol, propylene glycol and dipropylene glycol, glycol diethers such as methyl and ethyl diethers of ethylene glycol, diethylene glycol and dipropyleneglycol. or urea, glycerol, isopropanol, propylene glycol monomethyl ether, di- or tripropylene glycol monomethyl ether or carbohydrates such as glucose, mannose, fructose, galactose, sucrose, lactose, maltose, xylose, arabinose, sorbitol, mannitol, trehalose, raffinose or derivatives thereof. However, those skilled in the art will appreciate that it is possible to utilize different antifreezing agents without departing from the scope of the present invention. The antifreezing agents are commercially manufactured and available through various companies.

According to an embodiment, the chelating or complexing or sequestering agents which are used in the pesticidal composition include, but not limited to one or more of lignosulphonates, polycarboxylic acids such as polyacrylic acid and the various hydrolyzed poly(methyl vinyl ether/maleic anhydride); N-hydroxyethyliminodiacetic acid, nitrilotriacetic acid (NTA), N,N,N′,N′-ethylenediaminetetraacetic acid, N-hydroxyethyl-N, N′,N′-ethylenediaminetriacetic acid and N,N,N′,N″,N″-diethylenetriaminepentaacetic acid; α-hydroxy acids, such as citric acid, tartaric acid and gluconic acid; orthophosphates, such as trisodium phosphate, disodium phosphate, monosodium phosphate; condensed phosphates, such as sodium tripolyphosphate, tetrasodium pyrophosphate, sodium hexametaphosphate and sodium tetrapolyphosphate; 5-sulfo-8-hydroxyquinoline; and 3,5-disulfopyrocatechol, polycarboxylates, ethylene diamine tetraacetic acid (EDTA), diethylenetriaminepentaacetic acid (DTPA), N-hydroxyethyl-ethylenediamine-triacetic acid (HEDTA), ethylenediaminediacetate (EDDA), ethylenediaminedi(o-hydroxyphenylacetic) acid (EDDHA), cyclohexane diamine tetraacetic acid (CDTA), polyethyleneaminepolyacetic acids, lignosulfonate, Ca—, K—, Na—, and ammonium lignosulfonates, fulvic acid, ulmic acid, citric acids, cyclodextrin, phytic acid, humic acid, pyrophosphate. However, those skilled in the art will appreciate that it is possible to utilize other chelating or complexing or sesquitering agents without departing from the scope of the present invention. The chelating or complexing or sesquitering agents are commercially manufactured and available through various companies.

According to an embodiment, the penetrant which is used in the pesticidal composition include, but not limited to one or more of alcohol, glycol, glycol ether, ester, amine, alkanolamine, amine oxide, quaternary ammonium compound, triglyceride, polyoxyethylenetrimethylolpropane hexaoleate, sorbitan monooleate, polyoxyethylene sorbitan monolaurate, polyoxyethylene trimethylolpropane trioleate, ethoxylated triglycerides, ethoxylated polyol esters, alkoxylated alkanols and also alkoxylated triglycerides fatty acid ester, fatty acid ether, N-methyl pyrrolidone, dimethylformamide, dimethylacetamide, or dimethyl sulfoxide, polyoxyethylene trimethylol propane monooleate, polyoxyethylene trimethylol propanedioleate, polyoxyethylene trimethylol propanetrioleate, polyoxyethylene sorbitan monooleate, polyoxyethylene sorbitol hexaoleate. However, those skilled in the art will appreciate that it is possible to utilize different penetrants without departing from the scope of the present invention. The penetrants are commercially manufactured and available through various companies.

According to an embodiment, the ultraviolet absorbent is selected from, but not limited to one or more of zinc oxide, titanium oxide, lignosulphonates, 2-(2′-hydroxy-5′-methylphenyl) benzotriazole, 2-ethoxy-2′-ethyloxazalic acid bisanilide, succinic acid dimethyl-1-(2-hydroxyethyl)-4-hydroxy-2,2,6,6-tetramethylpiperidine polycondensate, benzotriazole compounds such as 2-(2′-hydroxy-5 ‘-methylphenyl)benzotriazole and 2-(2’-hydroxy-4′-n-octoxyphenyl)benzotriazole; benzophenone compounds such as 2-hydroxy-4-methoxybenzophenone and 2-hydroxy-4-n-octoxybenzophenone; salicylic acid compounds such as phenyl salicylate and p-t-butylphenyl salicylate; 2-ethylhexyl 2-cyano-3,3-diphenyl acrylate, 2-ethoxy-2′-ethyl oxalic bisanilide, and dimethyl succinate-1-(2-hydroxyethyl)-4-hydroxy-2,2,6,6-tetramethylpiperidine polycondensate or derivatives or the like. However, those skilled in the art will appreciate that it is possible to utilize different ultraviolet absorbents, without departing from the scope of the present invention. Such ultraviolet absorbents are commercially manufactured and available through various companies.

According to an embodiment, the UV ray scattering agents include, but not limited to zinc oxide, titanium dioxide or the like may be used. However, those skilled in the art will appreciate that it is possible to utilize different UV ray scattering agents or mixtures thereof without departing from the scope of the present invention. Such UV ray scattering agents are commercially manufactured and available through various companies.

According to an embodiment, the humectant is selected from, but not limited to one or more of polyoxyethylene/polyoxypropylene copolymers, particularly block copolymers, such as the Synperonic PE series of copolymers available from Uniqema or salts, derivatives thereof. Other humectants are propylene glycol, monoethylene glycol, hexylene glycol, butylene glycol, ethylene glycol, diethylene glycol, poly (ethylene glycol), poly (propylene glycol), glycerol and the like; polyhydric alcohol compounds such as propylene glycol ether, derivatives thereof. Also other humectants include calcium chloride, sodium lactate, urea, polydextrose, sodium metaphosphate, amino acids such as proline; triacetin, etc. The non-ionic surfactants mentioned above also act as humectants.

However, those skilled in the art will appreciate that it is possible to utilize other conventionally known humectants without departing from the scope of the present invention. The humectants are commercially manufactured and available through various companies.

According to an embodiment, the humectant is present in the range of 0.1% to 90% w/w of the total composition. According to an embodiment, the humectant is present in the range of 0.1% to 70% w/w of the total composition. According to an embodiment, the humectant is present in the range of 0.1% to 60% w/w of the total composition. According to an embodiment, the humectant is present in the range of 0.1% to 50% w/w of the total composition. According to an embodiment, the humectant is present in the range of 0.1% to 30% w/w of the total composition. According to an embodiment, the humectant is present in the range of 0.1% to 10% w/w of the total composition.

According to an embodiment, the pesticidal composition can include at least one further active ingredient. According to an embodiment, the active ingredient can include at least one pesticidal active; nutrients selected from macronutrients, micro nutrients; bio stimulants; fertilizer; plant growth regulators; microbes; algae; bactereospores; and mixtures thereof. However, those skilled in the art will appreciate that it is possible to utilize other further active ingredient without departing from the scope of the present invention.

According to further embodiment, the pesticidal active can be one or more of According to an embodiment, the pesticidal actives include one or more of an antifoulant, an insecticide, a fungicide, a herbicide, a nematicide, a pheromone, a defoliant, an acaricide, a plant growth regulator, an algicide, an antifeedant, an avicide, a bactericide, a bird repellent, a biopesticide, a biocide, a chemosterilant, a safener, an insect attractant, an insect repellent, an insect growth regulator, a mammal repellent, a mating disrupter, a disinfectant, a molluscicide, an antimicrobial, a miticide, an ovicide, a fumigant, a plant activator, a rodenticide, a synergist, a virucide, a microbial pesticide, a plant incorporated protectant, other miscellaneous pesticidal actives or salts or derivatives and mixtures thereof, etc. However, those skilled in the art will appreciate that it is possible to utilize other pesticidal active without departing from the scope of the present invention.

According to an embodiment, the further active ingredient can be present in the concentration range of 0.1% w/w to 90% w/w of the total composition.

It has been surprisingly found that the pesticidal composition of the present invention has enhanced and improved physical properties of dispersibility, suspensibility, wettability, viscosity, pourability, provides ease of handling and also reduces the loss of material while handling the product at the time of packaging as well as during field application.

According to an embodiment, viscosity of the liquid composition is determined as per CIPAC MT-192. According to an embodiment, the pesticide composition has a viscosity at 25° C. of about 10 cps to about 3000 cps. According to an embodiment, viscosity of the liquid composition is determined as per CIPAC MT-192. According to an embodiment, the pesticide composition has a viscosity at 25° C. of about 50 cps to about 3000 cps. According to an embodiment, the pesticidal composition has a viscosity at 25° C. of about 50 cps to about 2000 cps. According to an embodiment, the pesticidal composition has a viscosity at 25° C. of about 10 cps to about 2500 cps. According to an embodiment, the pesticidal composition has a viscosity at 25° C. of about 10 cps to about 2000 cps. According to an embodiment, the pesticidal composition has a viscosity at 25° C. of about 10 cps to about 1500 cps. According to an embodiment, the pesticidal composition has a viscosity at 25° C. of about 10 cps to about 1200 cps. According to an embodiment, the pesticidal composition has viscosity at 25° C. of about 10 cps to about 500 cps. According to an embodiment, the pesticidal composition has a viscosity at 25° C. of about less than 500 cps. According to an embodiment, the pesticidal composition has viscosity at 25° C. of about 10 cps to about 400 cps. According to an embodiment, the pesticidal composition has viscosity at 25° C. of about 10 cps to about 300 cps.

According to an embodiment, the liquid suspension composition of the present invention is easily pourable. The pourability is the measure of percent of residue.

According to an embodiment, the pourability of the composition is determined as per CIPAC MT-148.1. According to a further embodiment, the pourability of the pesticidal composition is less than 5% residue. According to further embodiment, the pourability of the pesticidal composition is preferably less than 2.5% residue. According to further embodiment, the pourability of the pesticidal composition is more preferably less than 2.0% residue.

According to an embodiment, the pesticidal composition has a dispersibility of at least 30%. According to an embodiment, the pesticidal composition has a dispersibility of at least 40%. According to an embodiment, the pesticidal composition has a dispersibility of at least 50%. According to an embodiment, the pesticidal composition has a dispersibility of at least 60%. According to an embodiment, the pesticidal composition has a dispersibility of at least 70%. According to an embodiment, the pesticidal composition has a dispersibility of at least 80%. According to an embodiment, the pesticidal composition has a dispersibility of at least 90%. According to an embodiment, the pesticidal composition has a dispersibility of at least 99%. According to an embodiment, the pesticidal composition has a dispersibility of 100%. Dispersibility of the composition of the present application, was determined as per the standard CIPAC test, MT 174.

Suspensibility is defined as the amount of active ingredient suspended after a given time in a column of liquid, of stated height, expressed as a percentage of the amount of active ingredient in the original suspension. The test for suspensibility is done as per the CIPAC Handbook, “MT 184 Test for Suspensibility”.

According to an embodiment, the pesticidal composition has a suspensibility of at least 30%. According to an embodiment, the pesticidal composition has suspensibility of at least 40%. According to an embodiment, the pesticidal composition has a suspensibility of at least 50%. According to an embodiment, the pesticidal composition has a suspensibility of at least 60%. According to an embodiment, the pesticidal composition has a suspensibility of at least 70%. According to an embodiment, the pesticidal composition has a suspensibility of at least 80%. According to an embodiment, the pesticidal composition has a suspensibility of at least 90%. According to an embodiment, the pesticidal composition has a suspensibility of at least 99%. According to an embodiment, the pesticidal composition has a suspensibility of 100%.

According to an embodiment, the pesticidal composition demonstrates superior stability in terms of suspensibility under accelerated storage condition (ATS). According to an embodiment, the pesticidal composition demonstrates suspensibility of at least 90% under ATS. According to an embodiment, the pesticidal composition demonstrates suspensibility of at least 80% under ATS. According to an embodiment, the pesticidal composition demonstrates suspensibility of at least 70% under ATS. According to an embodiment, the pesticidal composition demonstrates suspensibility of at least 60% under ATS. According to an embodiment, the pesticidal composition demonstrates suspensibility of at least 50% under ATS. According to an embodiment, the pesticidal composition demonstrates suspensibility of at least 40% under ATS. According to an embodiment, the pesticidal composition demonstrates suspensibility of at least 30% under ATS.

According to an embodiment, the pesticidal composition demonstrates dispersibility of at least 90% under ATS. According to an embodiment, the pesticidal composition demonstrates dispersibility of at least 80% under ATS. According to an embodiment, the pesticidal composition demonstrates dispersibility of at least 70% under ATS. According to an embodiment, the pesticidal composition demonstrates dispersibility of at least 60% under ATS. According to an embodiment, the pesticidal composition demonstrates dispersibility of at least 50% under ATS. According to an embodiment, the pesticidal composition demonstrates dispersibility of at least 40% under ATS. According to an embodiment, the pesticidal composition demonstrates dispersibility of at least 30% under ATS.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined. According to another embodiment, the pesticidal composition in the form of water dispersible granules, spheronised granule or broadcast granules or water disintegrable granule has wettability of less than 2 minutes. According to another embodiment, the wettability of less than 1 minute. According to another embodiment, the pesticidal composition has wettability of less than 30 seconds.

According to an embodiment, the pesticidal composition demonstrates superior stability towards heat, light, temperature and caking. According to an embodiment, the stability exhibited by the pesticidal composition is at least 3 years. According to further embodiment, the stability exhibited by the pesticidal composition is at least 2 years. According to further embodiment, the stability exhibited by the pesticidal composition is at least 1 year. According to further embodiment, the stability exhibited by the pesticidal composition is at least 6 months.

According to an embodiment, the present invention relates to a process of preparing the pesticidal composition of the present invention comprising elemental sulphur present in the range of 1% w/w to 95 w/w of the total composition, choline salt of pelargonic acid present in the range of 0.01% w/w to 50% w/w of the total composition and at least one agrochemically acceptable excipient.

According to another embodiment, the pesticidal composition in the form of water dispersible granules or spheronised granules, is made by various techniques such as spray drying, fluidized bed granulation, pan granulation, pin agglomerator, spheronizer, freeze drying etc. The granules can also be extruded through the extruder to obtain extruded granules.

According to an embodiment, the process of preparing a water dispersible granular pesticidal composition involves milling a blend of elemental sulphur; choline salt of pelargonic acid and at least one excipient to obtain slurry or a wet mix. The process of preparing a water dispersible granular pesticidal composition, according to an embodiment, particularly involves milling a blend of elemental sulphur; choline salt of pelargonic acid followed by addition of at least one filler or carrier and at least one excipient to obtain slurry or a wet mix. The choline salt of pelargonic acid can be added to the blend of elemental sulphur and at least one excipient either before or after milling the blend to obtain the wet mix. The wet mix obtained is then dried, for instance in a spray dryer, fluid bed dryer or any suitable granulating equipment, followed by sieving to remove the undersized and oversized granules to obtain water dispersible granules of the desired size if required. However, those skilled in the art will appreciate that it is possible to modify or alter or change the process or process parameters to obtain water dispersible granular composition without departing from the scope of the present invention. Water is added to the dry powder and the mixture is blended to obtain a wet mass, which is then extruded through an extruder to obtain the granules of desired size. The granules can also be formed with hot melt extrusion. However, those skilled in the art will appreciate that it is possible to modify or alter or change the process or process parameters to obtain granular composition without departing from the scope of the present invention.

The granules obtained from the granulator can also be dried in open air or air-dried, to remove any residual moisture, if any. However, those skilled in the art will appreciate that it is possible to modify or alter or change the process or process parameters without departing from the scope of the present invention.

According to another embodiment, the invention further relates to the process for preparing the spheronised granules which involves milling a blend of elemental sulphur; choline salt of pelargonic acid and at least one excipient to obtain slurry or a wet mix. The process particularly involves milling a blend of elemental sulphur; choline salt of pelargonic acid followed by addition of and at least one excipient to obtain a wet mix. According to an embodiment the composition comprises at least one filler or carrier during the process of preparation of making the composition. The choline salt of pelargonic acid can be added to the blend of elemental sulphur and at least one excipient either before or after milling the blend to obtain the wet mix. The wet mix obtained is then dried, for instance in a spray dryer, fluid bed dryer or any suitable granulating equipment, followed by sieving to remove the undersized and oversized granules to obtain granules. The powder or the fine granules is further subjected to agglomeration in an agglomerator to obtain granules of size of about 0.1 mm to 6 mm. The agglomerator can include various equipment's such as a disc pelletizer or pan granulator, pin agglomerator, spheronizer, or combinations thereof.

According to an embodiment, the invention relates to a process for preparing wettable powder composition. The process comprises mixing choline salt of pelargonic acid with excipients to form a dry mass using a mass mixer. Further adding elemental sulphur and other ingredients to the mixture and passing the mixture through a jet mill to obtain powder with desired particle size.

According to another embodiment, the invention relates to a process for preparing the liquid suspension composition.

According to an embodiment, the invention relates to a process of preparation of the liquid suspension pesticidal composition, the process comprising: homogenizing mixture of elemental sulphur; choline salt of pelargonic acid and at least one excipient to obtain a suspension; and wet milling the obtained suspension to provide the liquid suspension composition. The choline salt of pelargonic acid can also be added to the suspension after milling mixture of elemental sulphur and at least one excipient to obtain a suspension. However those skilled in the art will appreciate that it is possible to modify or alter or change the process or process parameters without departing from the scope of the present invention.

According to an embodiment, the gel composition of the present invention is prepared by adding more amounts of viscosity modifiers to the suspension concentrate or liquid suspension composition. However, those skilled in the art will appreciate that it is possible to modify or alter or change the process or process parameters to obtain gel composition without departing from the scope of the present invention.

According to an embodiment, the invention further relates to the process of preparation of the pesticidal composition in the form of oil dispersion. The process involves mixing an oil, choline salt of pelargonic acid and elemental sulphur; one or more of emulsifier or surfactant and optionally one or more other agrochemical excipients such as rheology modifiers under high shear, thereby grinding the sample to desired particle size to obtain the oil dispersion composition. However, those skilled in the art will appreciate that it is possible to modify or alter or change the process or process parameters to obtain oil dispersion composition without departing from the scope of the present invention.

According to an embodiment, the invention further relates to a method of application of the composition.

According to an embodiment, the invention also relates to a method of protecting the crop, controlling plant pathogen, controlling pest, improving the crop health and growth, enhancing the crop yield, strengthening the plant, the method comprising treating at least one of a plant, crop, plant propagation material, locus or parts thereof, a seed, seedling or surrounding soil with the pesticidal composition which includes elemental sulphur present in the range of 1 w/w to 95 w/w of the total composition and choline salt of pelargonic acid present in the range of 0.01% w/w to 70% w/w of the total composition. The composition may be sprayed directly to the plant, such as its foliage or applied to the plant propagation material, before it is sown or planted, or to the locus thereof.

The composition is applied through a variety of methods. Methods of applying to the soil include any suitable method, which ensures that the composition penetrates the soil, for example nursery tray application, in furrow application, soil drenching, soil injection, drip irrigation, sprinkler irrigation, seed treatment, seed painting and such other methods. The composition is particularly applied in the form of a foliar spray.

The rates of application or the dosage of the composition depends on the type of use, the type of crops, or the specific active ingredients in the composition but is such that the pesticidal active ingredient, is in an effective amount to provide the desired action (such as crop protection, crop yield).

According to an embodiment, the composition of the present invention is synergistic in nature and provides good control on plant pathogens such as fungus, bacteria as compared to application of individual actives. It was also noted that the composition of the present invention also demonstrated herbicidal activity. Further such combinations help in improving the crop yield, crop characteristics etc. Thus, it has been observed that the compositions of the present invention, demonstrate enhanced, efficacious and superior behavior in the fields at reduced dosage.

### A. PREPARATION EXAMPLES

The following examples illustrate the basic methodology and versatility of the composition of the invention. It should be noted that this invention is not limited to these exemplifications and can be extrapolated to overall claimed concentration range of the components.

### Example 1: Water Dispersible Granular Composition Comprising 40% Elemental Sulphur and 30% Choline Pelargonate

Water dispersible granular composition was prepared by blending 40 parts of elemental sulphur, 30 parts of choline pelargonate, 15 parts of magnesium alumino silicate, 10 parts of lignin sulfonate and 5 parts of naphthalene sulfonate. The blend obtained was milled to get a powder of less than 50 microns particle size. The powder was mixed with water in a suitable mixing equipment to form a slurry or wet mix.

The slurry obtained was wet ground in suitable wet grinding equipment. The wet milled slurry obtained was spray dried at an inlet temperature less than 140° C. and outlet temperature less than 90° C. to get a granular powder. The composition had the particle size of about 12 microns and granule size of 1.5 mm. The composition had a dispersibility of 80%, suspensibility of 85%, and wettability of less than 20 sec. The composition further demonstrated suspensibility of about 75% and dispersibility of about 78% under accelerated storage condition.

### Example 2. Water Dispersible Granular Composition Comprising 25% Elemental Sulphur and 40% Choline Pelargonate

The granules are prepared as per process described in example 1 by blending 25 parts of elemental sulphur, 40 parts of choline pelargonate, 15 parts of metal silicate, 2 parts of silica, 10 parts of lignin sulfonate, 4 parts of phenol naphthalene sulfonate condensate and 4 parts of china clay. The composition had the particle size of about 18 microns and granule size of 2.0 mm. The composition has a dispersibility of 70%, suspensibility of 65%, wettability of less than 40 sec. The composition further demonstrated dispersibility of 75% and suspensibility of about 80% under accelerated storage condition.

### Example 3. Water Dispersible Granular Composition of 90% Elemental Sulphur and 1% Choline Pelargonate

The granules are prepared as per process described in example 1 by blending 90 parts of elemental sulphur, 1 parts of choline pelargonate, 5 parts of naphthalene sulfonate condensate and 4 parts of polycarboxylate. The composition had the particle size of about 8 microns and granule size of 1.5 mm. The composition has a dispersibility of 90%, suspensibility of 95%, wettability of less than 20 sec. The composition further demonstrated dispersibility of 85% and suspensibility of about 90% under accelerated storage condition.

### Example 4. Extruded Granular Composition of 70% Elemental Sulphur and 10% Choline Pelargonate

The extruded granules are prepared by blending 70 part of elemental sulphur, 10 part of choline pelargonate, 5 part of sodium phenyl sulphonic acid, 6 part of silica, 5 part of sodium salt of fatty acid and 4 part of china clay. The blend obtained is dry milled to obtain mixture of desired particle size. Water is added to the blend to form dough and is extruded to obtain extruded granules. The composition had the particle size of about 25 microns and granule size of about 5.5 mm. The composition has a dispersibility of 85%, suspensibility of 75%, wet sieve retention value of 0.3%, wettability of less than 60 sec. The composition further demonstrated dispersibility of 79% and suspensibility of about 70% under accelerated storage condition.

### Example 5: Extruded Granular Composition of 40% Elemental Sulphur and 25% Choline Pelargonate

The extruded granules are prepared as per example 3 and comprises 40 parts of elemental sulphur, 25 parts of choline pelargonate, 10 parts of metal silicate, 10 parts of lignin sulfonate, 12 parts of kaolin and 3 parts of naphthalene sulfonate condensate. The composition had the particle size of about 20 microns and granule size of about 4 mm. The composition has a dispersibility of 55%, suspensibility of 55%, and wettability of less than 65 sec. The composition further demonstrated dispersibility of 45% and suspensibility of about 49% under accelerated storage condition.

### Example 6: Spheronised Granular Composition of 40% Elemental Sulphur and Choline Pelargonate 30%

The composition was prepared by blending 40 part of elemental sulphur and 30 part of choline pelargonate, 14 parts of silica, 6 parts of naphthalene sulphonate condensate and 10 part of sodium ligno sulphonate to obtain a blend. The blend obtained was milled to get a powder of less than 50-micron particle size. The powder was mixed with water in a suitable mixing equipment to form a slurry. The slurry obtained was wet ground in suitable wet grinding equipment. The wet milled slurry obtained was spray dried at an inlet temperature less than 180° C. and outlet temperature less than 85° C. to get a granular powder with less moisture. The spray dried powder thus obtained was subjected to agglomeration in a fluid bed dryer, followed by a pin agglomerator and a pan granulator. The speed of the pan granulator was kept at around 35 rpm, to obtain the agricultural granular composition. Water was incorporated at the time of agglomeration. The granules obtained were then further dried in a post fluid bed drier to remove residual moisture, at a temperature around 70° C.

The sample had a granule size of 5 mm, particle size of 25 micron. The granular composition had wettability of less than 100 second, suspensibility of 49% and dispersibility of 45%. The composition further demonstrated dispersibility of 38% and suspensibility of about 40% under accelerated storage condition.

### Example 7: Wettable Powder Composition of 80% Elemental Sulphur and 2% Acetyl Choline Pelargonate

The wettable powder is prepared by mixing 2 parts of acetyl choline pelargonate with 5 parts of kaolin and 13 parts of sodium lignin sulfonate to form a dry mass using a mass mixer followed by addition of 80 parts of elemental sulphur and the mixture is passed through a jet mill to a particle size of less than 30 microns. The composition has suspensibility of 50% and dispersibility of 45%. The composition further demonstrated dispersibility of 40% and suspensibility of about 44% under accelerated storage condition.

### Example 8: Liquid Suspension Composition of 35% Elemental Sulphur and 25% Choline Pelargonate

Liquid suspension composition was prepared by mixing 35 part of elemental sulphur, 25 part of choline pelargonate, 6 parts of monoethylene glycol, 4 parts of Tristyrylphenol ester, sodium benzoate 0.5 parts and 29.34 parts of water and homogenised by feeding them into a vessel provided with stirring facilities until the total mixture was homogeneous. Subsequently, the suspension obtained was passed through the wet mill to obtain a suspension with 7 microns particle size. Then, 0.16 part of xanthan gum was added under continuous homogenization to obtain the suspension concentrate. The composition has suspensibility of about 95%, dispersibility of 90%, viscosity of about 550 cps, pourability of less than 1.5. The composition has suspensibility of about 89%, dispersibility of 90% and viscosity of about 600 cps under accelerated storage condition.

### Example 9: Liquid Suspension Composition Comprising 55% of Elemental Sulphur and 0.7% of Choline Pelargonate

The liquid suspension is prepared as per Example 7 and comprises 55 parts of elemental sulphur, 0.7 parts of choline pelargonate, 4 parts of naphthalene sulphonate condensate, 5 parts of monoethylene glycol, 0.13 parts of xanthan gum, 0.1 part of benzisothiazolinone and 35.07 parts of water. The composition has particle size of about 10 micron, suspensibility of about 87%, dispersibility of 90%, viscosity of about 800 cps, and pourability of less than 1.7%. The composition has suspensibility of about 80%, dispersibility of 85% and viscosity of about 850 cps under accelerated storage condition.

### Example 10: Liquid Suspension Composition Comprising 55% Elemental Sulphur and 3.45% of Choline Pelargonate

The liquid suspension is prepared as per Example 7 and comprises 55 parts of elemental sulphur, 3.45 parts of choline pelargonate, 4 parts of polycarboxylate, 5 parts of glycerol, 2 parts of Tristyrylphenol ester, 0.28 parts of carboxymethyl cellulose, 0.19 part of bronopol and 30.08 parts of water. The composition has particle size of about 23 micron, suspensibility of about 75%, dispersibility of 70%, viscosity of about 1500 cps, and pourability of less than 2.5. The composition has suspensibility of about 69%, dispersibility of 64% and viscosity of about 1550 cps under accelerated storage condition.

### Example 11. Suspoemulsion Composition Comprising 10 Parts of Elemental Sulphur and 40 Parts of Choline Pelargonate

The composition comprises 10 parts of elemental sulphur, 40 parts of choline pelargonate, 8 parts of propylene glycol, 2 parts of Tween 85, 3 parts of polycarboxylate sodium, 1.18 part of swellable clay, 0.1 part of sodium benzoate and 35.72 parts of water. The composition had particle of about 12 microns. The sample had suspensibility of about 91%, viscosity of about 600 cps. The composition had suspensibility of about 86% under accelerated storage condition.

### B. FIELD STUDIES

To study effect of pesticidal composition of elemental sulphur and choline pelargonate according to an embodiment of the present invention:

Experiment No. 1: Lab Trial (in-vitro anti-fungal test) was conducted for the evaluation of an efficacy of the composition of the present invention on strains of various fungal pathogens such as Fusarium oxysporum causing wilt disease, Aspergillus niger causing collar rot disease, Rhizoctonia spp causing collar rot, root rot disease, Alternaria spp causing leaf spot, at different concentrations of the composition.

The treatments (T1, T2, T3 and T4) with the compositions of the present invention as mentioned below were screened by the “Agar Plate Assay method” at concentrations of 10 gm/L, 20 gm/1 and 40 gm/L respectively against the fungi pathogens as mentioned above. The observations on average colony diameter of fungal pathogen were recorded and presented in Table 1 in form of % inhibition of the mycelial growth. Table 1: Evaluation of the composition of present embodiment against pathogenic fungi in vitro.
T1: Sulphur 55%+3.45% choline pelargonate liquid suspension composition of as per the embodiment of the present invention
T2: Sulphur 55%+5% choline pelargonate liquid suspension composition as per the embodiment of the present invention
T3: Sulphur 55%+5% choline pelargonate water dispersible granular composition as per the embodiment of the present invention
T4: Sulphur 80%+5% choline pelargonate dispersible granular composition as per the embodiment of the present invention

TABLE 1

| | Inhibition of mycelial growth | | | |
|---|---|---|---|---|
| Concentration of | for different pathogenic fungi | | | |
| active ingredient | Fusarium | Rhizoctonia | Aspergillus | Alternaria |
| (gm/L) | spp | spp | spp | spp |
| T1: 10 | 76 | 70 | 64 | 65 |
| 20 | 100 | 100 | 88 | 86 |
| 40 | 100 | 100 | 95 | 100 |
| T2: 10 | 62 | 76 | 69 | 65 |
| 20 | 100 | 95 | 90 | 88 |
| 40 | 100 | 100 | 99 | 100 |
| T3: 10 | 68 | 76 | 68 | 69 |
| 20 | 96 | 98 | 94 | 88 |
| 40 | 100 | 99 | 100 | 100 |
| T4: 10 | 88 | 89 | 85 | 78 |
| 20 | 98 | 100 | 97 | 98 |
| 40 | 100 | 100 | 100 | 100 |

It was noted that treatments T1, T2, T3 and T4 according to an embodiment of the present invention appear as effective treatments to control the pathogen Rhizoctonia spps. It can be seen from Table 1 that the % growth control with T1, T2, T3 and T4 according to an embodiment of the present invention at an active ingredient concentration of 10 gm/L was 70%, 76%, 76% and 89% respectively whereas at a concentration of 40 gm/L was about 100% for all treatments and for T3 it was about 99%. Thus, the composition of the elemental sulphur and choline pelargonate in the form of water dispersible granules, dispersible granules and suspension concentrate with particle size less than 50 microns illustrates excellent effect against tested fungus at a dosage of 40 gm/L. Further, it was observed that the compositions of the present invention T1, T2, T3 and T4 show incremental efficacy when tested from 10 to 20 gm/L. Similarly, as can be seen from the Table 1, the composition of the present invention was found to be efficacious in controlling the other tested fungus.

Experiment no 2: To study the effect of combination of elemental sulphur and choline pelargonate on powdery mildew in chilly.

The field trials were carried out to study the effect of combination of elemental sulphur and choline pelargonate on fungal pathogen in chilly crop. The trial was laid out during kharif season i.e. June to September in Randomized Block Design (RBD) with six treatments including untreated control, replicated six times. The test product sample, sulphur and choline pelargonate, alone and in combination with prescribed dose were applied as foliar application at 60 days after sowing of seeds in trial plot. Two applications was given at 15 days interval. Powdery mildew disease was recorded at 10 days after 1st application & 2nd application respectively. The chilly crop in trial field was raised following good agricultural practice.

### Details of Experiment

| | |
|---|---|
| a) Trial Location: | Guntur, Andra Pradesh |
| b) Crop: | Chilly |
| c) Target Pathogen: | Powdery mildew (Leveillula taurica) |
| c) Experiment season: | Kharif |
| d) Trial Design: | RBD with six replications |
| f) Treatment: | Six |
| g) Plot size: | 5 m × 10 m = 50 sq · m |
| h) Date of Trial initiation: | 15 Jul. 2020 |
| i) Date of application: | 15 Sep. 2020 & 30 Sep. 2020 |
| 10 Days after 2nd application: | 30 Sep. 2020 and 10 Oct. 2020 |
| k) Water volume used: | 500 L/ha |
| l) Method of application: | Foliar application |
| j) Assessment: | Disease severity Index at 3-5% diseases |
| | incidence |
| k) Date of Harvesting: | |

The observation on chilly were recorded at 10 days after first spray and 10 days after second spray from each plot and the percentage control was calculated from the mean value using following formula:

Control (%)=[Damage in control plot−Damage in treated plot)/Damage in control plot]×100

The data on control against powdery mildew along with the yield was recorded at harvest and is presented in the Table 2.

TABLE 2
Effect of combination of elemental sulphur and choline pelargonate
against powdery mildew in Chilly

| | | | Dosage | | | | | | |
|---|---|---|---|---|---|---|---|---|---|
| | | Dosage | Choline | | 10DAA | 10DAA | % | | Crop |
| Sr | | Sulphur | pelargonate | | 1st | 2nd | Disease | Yield | Phyto- |
| No | Treatments | (Ga.i./ha) | (Ga.i./ha) | BS | spray | spray | control | (Qtl/ha) | toxicity |
| 1 | Sulphur | 2200 | 200 | 3.5 | 2.9 | 1.9 | 81+ | 132 | 0 |
| | 55% + | | | | | | | | |
| | Choline | | | | | | | | |
| | pelargonate | | | | | | | | |
| | 5% | | | | | | | | |
| | WDG | | | | | | | | |
| 2 | Sulphur | 2200 | 200 | 3.2 | 3.1 | 2.5 | 77+ | 129 | 0 |
| | 55% + | | | | | | | | |
| | Choline | | | | | | | | |
| | pelargonate | | | | | | | | |
| | 5% SC | | | | | | | | |
| 3 | Sulphur | 2200 | 200 | 3.4 | 3.1 | 2.8 | 76+ | 133 | 0 |
| | 27.5% + | | | | | | | | |
| | Choline | | | | | | | | |
| | pelargonate | | | | | | | | |
| | 2.5% | | | | | | | | |
| | SC | | | | | | | | |
| 4 | Sulphur | 2200 | 0 | 3.2 | 6.1 | 5.9 | 51 | 125 | 0 |
| | 80% | | | | | | | | |
| | WDG | | | | | | | | |
| 5 | Choline | 0 | 200 | 2.5 | 4.1 | 10.6 | 40 | 100 | 0 |
| | pelargonate | | | | | | | | |
| | 5% | | | | | | | | |
| | water | | | | | | | | |
| | dispersible | | | | | | | | |
| | granule | | | | | | | | |
| 6 | Untreated | NA | NA | 2.9 | 8.2 | 16.5 | NA | 90 | NA |
| | check | | | | | | | | |

+Synergistic; BS—Before spary; 10DAA 1^{st} spray—10 Days after first spray; 10DAA 2^{nd} spray—10 Days after second spray; SC—suspension concentrate; WDG—water dispersible granules

It can be observed from the data presented in table 2 that composition comprising elemental sulphur and choline pelargonate in the form of liquid suspension or water dispersible granule prepared as per embodiment of the present invention is synergistic in nature and effective in controlling powdery mildew in chilly. The synergistic composition prepared as per embodiment of the present invention also has improved the yield of crops as compared to individual application of sulphur, choline pelargonate and untreated plot.

“Synergy” is as defined by Colby S. R. in an article entitled “Calculation of the synergistic and antagonistic responses of herbicide combinations” published in Weeds, 1967, 15, p. 20-22. The action expected for a given combination of two active components can be calculated as follows:

E=X+Y−(XY/100)

### Where,

E=Expected % effect by mixture of two products X and Y in a defined dose.
X=Observed % effect by product A
Y=Observed % effect by product B
The synergy factor (SF) is calculated by Abbott's formula (Abbott, 1925).
SF=Observed effect/Expected effect
Where, SF>1 for Synergistic reaction; SF<1 for antagonistic reaction; SF=1 for additive reaction.

When the percentage of yield effect observed (E) for the combination is greater than the expected percentage, synergistic effect of the combination can be inferred. When the percentage of yield effect observed for the combination is equal to the expected percentage, merely an additive effect may be inferred, and wherein the percentage of yield effect observed for the combination is lower than the expected percentage, an antagonistic effect of the combinations can be inferred.

For instance, on comparing treatment T1 (Sulphur 55%+Choline pelargonate 5% WDG @ 4000 g/acre as per embodiment of the present invention) with T4 (Sulphur 80% WG) and T5 (Choline pelargonate 5% WDG) applied at same dosage, it was noted that treatment T1 control of 81% whereas treatment T4 and T5 demonstrated 51% and 40% control against powdery mildew. The percent yield increase as compared to untreated plot with T1 was about 46.6%. The pest control and efficacy data as presented in table 2 indicates that the combination of sulphur and choline pelargonate in the form of water dispersible granule or liquid suspension with the particles less than 50 microns is synergistic in nature.

Experiment no 3: To study the effect of combination of elemental sulphur and choline pelargonate on powdery mildew in cucumber.

The field trials were carried out to study the effect of combination of elemental sulphur and choline pelargonate on fungal pathogen in cucumber crop. The trial was laid out during kharif season i.e. June to September in Randomized Block Design (RBD) with six treatments including untreated control, replicated six times. The test product sample, sulphur and choline pelargonate, alone and in combination with prescribed dose were applied as foliar application at 60 days after sowing of seeds in trial plot. Two applications was given at 15 days interval. Powdery mildew disease was recorded at 10 days after 1st application & 2nd application respectively. The cucumber crop in trial field was raised following good agricultural practice.

### Details of Experiment

| | |
|---|---|
| a) Trial Location: | Andra Pradesh |
| b) Crop: | Cucumber |
| c) Variety: | Pusasanyog |
| c) Target Pathogen: | Powdery mildew (Erysiphe |
| | cichoracearum) |
| c) Experiment season: | Kharif |
| d) Trial Design: | RBD with five replications |
| f) Treatment: | Six |
| g) Plot size: | 5 m × 10 m = 50 sq · m |
| h) Date of Trial initiation: | 15 Aug. 2020 |
| i) Date of application: | 25 Oct. 2020 & 10 Nov. 2020 |
| 10 Days after 2nd application: | 10 Nov. 2020 |
| k) Water volume used: | 500 L/ha |
| l) Method of application: | Foliar application |
| j) Assessment: | Disease severity Index at 3-5% diseases |
| | incidence |

The observation on Cucumber were recorded at 10 days after first spray and 10 days after second spray from each plot and the percentage control was calculated from the mean value using following formula:

Control (%)=[Damage in control plot−Damage in treated plot)/Damage in control plot]×100

The data on control against powdery mildew along with the yield was recorded at harvest and is presented in the Table 3.

TABLE 3
Effect of combination of elemental sulphur and choline pelargonate in
Cucumber

| | | | Dosage | | | | | | |
|---|---|---|---|---|---|---|---|---|---|
| | | Dosage | Choline | | 10DAA | 10DAA | % | | Crop |
| Sr | | Sulphur | pelargonate | | 1st | 2nd | Disease | Yield | Phyto- |
| No | Treatments | (Ga.i./ha) | (Ga.i./ha) | BS | spray | spray | control | (Qtl/ha) | toxicity |
| 1 | Sulphur | 1000 | 1600 | 5.5 | 1.5 | 2.1 | 90 | 155 | 0 |
| | 25% + | | | | | | | | |
| | Choline | | | | | | | | |
| | pelargonate | | | | | | | | |
| | 40% | | | | | | | | |
| | extruded | | | | | | | | |
| | granules | | | | | | | | |
| 2 | Sulphur | 1000 | 1600 | 4.5 | 1.4 | 1.9 | 91 | 160 | 0 |
| | 20% + | | | | | | | | |
| | Choline | | | | | | | | |
| | pelargonate | | | | | | | | |
| | 35% | | | | | | | | |
| | water | | | | | | | | |
| | dispersible | | | | | | | | |
| | granules | | | | | | | | |
| 3 | Sulphur | 1000 | 1600 | 5 | 2.5 | 1.5 | 90 | 156 | 0 |
| | 20% + | | | | | | | | |
| | Choline | | | | | | | | |
| | pelargonate | | | | | | | | |
| | 35% | | | | | | | | |
| | liquid | | | | | | | | |
| | suspension | | | | | | | | |
| 4 | Sulphur | 1000 | | 5.7 | 5.8 | 8.2 | 61 | 135 | 0 |
| | 80% | | | | | | | | |
| | WDG | | | | | | | | |
| 5 | Choline | | 1600 | 3.5 | 3.8 | 6.8 | 69 | 129 | 0 |
| | pelargonate | | | | | | | | |
| | 40% | | | | | | | | |
| | water | | | | | | | | |
| | dispersible | | | | | | | | |
| | granule | | | | | | | | |
| 6 | Untreated | NA | | 5.7 | 7.8 | 24.5 | NA | 125 | NA |
| | check | | | | | | | | |

+Synergistic; BS—Before spary; 10DAA 1^{st} spray—10 Days after first spray; 10DAA 2^{nd} spray—10 Days after second spray; SC—suspension concentrate; WDG—water dispersible granules

The trial data in Table 3 indicates that the composition of sulphur and choline pelargonate is effective against the fungal pathogen on cucumber. For instance, on comparing treatment T2 (Sulphur 20%+Choline pelargonate 35% water dispersible granules) and T3 (Sulphur 20%+Choline pelargonate 35% liquid suspension) applied at 5000 gm/ha with T4 (Sulphur 80% WDG) and T5 (Choline pelargonate 40% WDG) it was observed that treatment T2 and T3 demonstrated 91% and 90% control respectively against powdery mildew whereas T5 demonstrated 69% control and T6 depicted 61% control against the fungal disease. The yield with T2 was about 160Qtl/ha and T3 was 156 Qtl/ha whereas with T5 and T6 it was about 135 Qtl/ha and 129 Qtl/ha respectively. The pest control and efficacy data as presented in table 3 clearly indicates that the combination of sulphur and choline pelargonate with the particles less than 50 microns is synergistic in nature.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

1-17. (canceled)

18. A pesticidal composition, comprising:
an elemental sulphur in the range of 1% w/w to 95% w/w of the total composition;
choline salt of pelargonic acid in the range of 0.01% w/w to 50% w/w of the total composition; and
at least one agrochemically acceptable excipient; wherein the composition comprises particles in the size range of from 0.1 micron to 50 microns.

19. The pesticidal composition of claim 18, wherein the choline salt of pelargonic acid is choline pelargonate, acetyl choline pelargonate, or mixtures thereof.

20. The pesticidal composition of claim 18, wherein the composition is in the form of a solid or a liquid or a gel.

21. The pesticidal composition of claim 20, wherein the composition in the form of a solid is in the form of water dispersible granules, water disintegrable granules, broadcast granules, spheronised granules, or wettable powder.

22. The pesticidal composition of claim 21, wherein suspensibility of the composition is at least 30%.

23. The pesticidal composition of claim 21, wherein dispersibility of the composition is at least 30%.

24. The pesticidal composition of claim 21, wherein the water disintegrable granules or broadcast granules or spheronised granules are in the size range of from 0.1 mm to 6 mm.

25. The pesticidal composition of claim 21, wherein the water dispersible granules are in the size range of from 0.1 mm to 2.5 mm.

26. The pesticidal composition of claim 20, wherein the liquid composition is in the form of suspoemulsion, oil dispersion, liquid suspension, flowable concentrate, combination of capsulated suspension and suspension concentrate (ZC) and seed dressing.

27. The pesticidal composition as claimed in claim 26, wherein the composition has viscosity in the range of 10 cps to 3000 cps.

28. The pesticidal composition as claimed in claim 26, wherein the composition has pourability of less than 5% residue.

29. The pesticidal composition of claim 26, wherein suspensibility of the composition is at least 30%.

30. The pesticidal composition of claim 26, wherein dispersibility of the composition is at least 30%.

31. The pesticidal composition of claim 18, wherein the composition further comprises at least one active ingredient selected from macronutrients, micro nutrients; bio stimulants; fertilizer; pesticidal actives; plant growth regulators; microbes; algae; bactereospores; and mixtures thereof.

32. The pesticidal composition of claim 18, wherein the agrochemically acceptable excipient is selected from at least one of surfactants, binders or binding agents, wetting agent, emulsifiers, disintegrating agents, fillers or carriers or diluents, coating agents, buffers or pH adjusters or neutralizing agents, antifoaming agents or defoamers, penetrants, ultraviolet absorbents, UV ray scattering agents, stabilizers, pigments, colorants, structuring agents, chelating or complexing or sesquitering agents, structuring agent, thickeners, suspending agents or suspension aid agents or anticaking agents or anti-settling agents, viscosity modifiers or rheology modifiers, tackifiers, humectants, sticking agents, anti-freezing agent or freeze point depressants, solvents, and mixtures thereof.

33. A process of preparing the pesticidal composition of claim 18, in the form of water dispersible granules, wherein the process comprises:
a. milling a blend of elemental sulphur; choline salt of pelargonic acid and, at least one agrochemically acceptable excipient to obtain a slurry or a wet mix; and
b. drying the wet mix to obtain the water dispersible granular composition; wherein the granules of the composition comprise of granules in size range of 0.1 mm to 2.5 mm.

34. A process of preparing the pesticidal composition of claim 18, in the form of spheronised granules, wherein the process comprises:
a. milling a blend of elemental sulphur; choline salt of pelargonic acid and, at least one agrochemically acceptable excipient to obtain a slurry or a wet mix;
b. drying the wet mix to obtain the water dispersible granular composition; wherein the granules of the composition comprise of granules in size range of 0.1 mm to 2.5 mm; and
c. water is added to the dry powder and the mixture is blended to obtain a dough or paste, which is then extruded through an extruder to obtain extruded granules in a size range of 0.1 mm to 6 mm; or
agglomerating the dry powder or fine granules obtained in step (b) in an agglomerator to obtain granular composition in a size range of 0.1 mm to 6 mm.

35. A process of preparing the pesticidal composition of claim 18, in the form of liquid suspension, wherein the process comprises:
a. homogenizing a mixture of elemental sulphur; choline salt of pelargonic acid and, at least one agrochemically acceptable excipient to obtain a suspension; and
b. wet milling the obtained suspension to provide the liquid suspension pesticidal composition.

36. A method of treating at least one of a plant, crop, plant propagation material, locus, parts thereof or seed, seedling, soil with the pesticidal composition of claim 18.
